(19) United States
(12) Patent Application Publication
(10) Pub. No.: US 2014/0313216 A1
(43) Pub. Date: Oct. 23, 2014

(54) Recognition and Representation of Image Sketches

(71) Applicant: Baldur Andrew Steingrimsson, Albuquerque, NM (US)

(72) Inventor: Baldur Andrew Steingrimsson, Albuquerque, NM (US)

(21) Appl. No.: 13/865,549

(22) Filed: Apr. 18, 2013

(51) Int. Cl. G06T 11/00; G06T 1/20

(52) U.S. Cl. CPC G06T 11/00; G06T 1/20; G06T 11/001
USPC 345/589; 345/520

(57) ABSTRACT

This invention implements a system for automatic recognition of human-assisted drawings, in a plurality of forms, be they hand-drawn on paper, marker board, with a stylus on a computer, made with a mouse, stylus, finger or other instrument on a personal computer, tablet computer, smart telephone or other medium. At the core of the invention is a pattern recognition engine, aimed at recognizing the graphical objects, handwritten text, equations or interconnects in the input image, and interpreting the significance of their relative association. The apparatus offers error correction, vector representation of the input sketch, as intermediate output, along with the recognized patterns, arranged in a hierarchical data structure, ready to be passed on for mining or assessment. The recognized patterns can be associated with mechanical design, electrical circuit design, mathematics, biology, physics, chemistry, computer science, natural sciences, medicine, or any other science- or engineering-based discipline making use of human-assisted drawings.

### CROSS REFERENCE TO RELATED APPLICATIONS

Provisional application No. 61/800,985, filed on Mar. 15, 2013.

### BACKGROUND OF THE INVENTION

1. Technical Field Description

Written correspondence, esp. in the world of natural science, physical science and engineering, consists of text, often combined with illustrative diagrams and sometimes equations. Facts and figures are the staples of such correspondence. Humans, however, often find it helpful to sketch up ideas and convey through graphical means. Through the representation and interrelations of the text, graphical objects, and if applicable, equations, image sketches can present an effective form of expression that is hard to succinctly articulate with text alone. Further, regular desktop, laptop or mobile tablet-based computing platforms have traditionally not possessed the same capabilities as us humans in interpreting the imagery content. Proper recognition of the graphical shapes (accurate image recognition), or of the handwritten text, has proven hard enough, let alone recognizing equations or making sense of the inter-relations.

2. Description of Prior Art

Prior art on image and sketch recognition reflects its applicability in a number of scientific and engineering disciplines. (Ouyang and Davis 2012) present a sketch recognition system, based on advanced concepts from the academic literature, and tailored primarily to chemical diagrams. Besides containing a wealth of excellent references from the academic literature, the exposition of the local likelihood metrics, indicating whether a candidate symbol belongs to a certain category (based on a set of features), of the joint likelihood metrics of multiple candidate symbols, of the graphical models and of the statistical inference is quite exemplary. Association between neighboring candidate symbols is captured in the joint likelihood metric which is determined based on the respective classification of these symbols as well as their spatial and/or temporal relationships. (Ouyang and Davis 2012) note that, on a prototype system (a tablet PC with a 3.7 GHz processor), it takes about 1 second to classify one illustrative sketch. Without commenting on the size (resolution) of the image or its content (the number of objects involved, or their inter-relations), (Ouyang and Davis 2012) conclude this is likely sufficient for real-time recognition. There is not much concern for equation recognition (aside from the chemical diagrams), and the extent and nature of the training is not articulated in much detail. It is simply noted that the training stage includes a training component that uses training data to learn a segmentation model (segmentation parameters), visual codebook and conditional random field (CRF) parameters. Excessive training requirements might limit the market acceptance of an actual reduction to practice of this invention. But more importantly, such a reduction would probably call for a graphical user interface (GUI), support for specific output format(s), a database system and a network interface, all of which are omitted from the invention.

In terms of industrial applications, (Feeney 2001) outlines a system for processing a freehand sketch drawn using a mouse connected to a desktop computer and intended for a computer-aided design (CAD) environment. Geometrical drawing parts or elements, sketched using the hand-controlled indicator, often lacking precision, are recognized and interpreted as points, straight lines, open arcs, circles and ellipses. The method also provides means for distinguishing, and interpreting relatively complex, multiple-part or multi-element strokes. This is accomplished by determining break locations for the elements along the stroke, and by recognizing the elements before re-constituting a stroke meeting the precision criteria. While some of the same fundamental concepts and ideas apply to the recognition of graphical objects in sketches drawn using a pen, pencil or with a stylus, the accuracy criteria are typically not the same, with finer features produced more easily with a pen, pencil or a stylus than with a mouse.

Then, aside from the recognition of complete image sketches, systems have been developed for analyzing, recognizing and enhancing collections of strokes, using time-based information and features of each stroke, along with some fuzzy logic (see for example (Tremblay 2009)). In this context, the collections of strokes can represent a graphical or a text symbol. (Ramani 2006) provides a sample of similar prior art. Here, the user supplied sketch is segmented, the primitives recognized, the segments verified and the sketch beautified.

Image recognition is sometimes considered separately from sketch recognition. In (Yamada 1991), an image recognition system is presented which automatically determines the match between the input image and a known model of a previously defined form. The model is provided in terms of directional features, for particular evaluation points, or for shift vectors from one evaluation point to the next. The input image is represented by density gradients for different directional planes. This type of matching might find application in manufacturing processes, e.g., in assessing conformity between units produced and the process specifications.

In terms of other samples of prior art, (Guha 2002)-(Lipscomb 1991) may be considered pertinent references. (Guha 2002) provides good insights into the essential ideas behind handwriting recognition algorithms applied to pressure-sensitive touchpads.

Released products for graphics, handwriting and equation recognition include ((SketchBoard 2013)-(MathType 2013)). These products supplement the open-source software available ((Neuroph 2013)-(Lipi 2013)).

Prior art related to the electronic capture, as opposed to the recognition, of handwritten sketches and text are listed in the Information Disclosure Statement enclosed.

### REFERENCES

(Ouyang and Davis 2012) T. Y. Ouyang and R. David. Sketch Recognition System. United States Patent Application Publication No. US 2012/0141032 A1. Jun. 7, 2012.
(Feeney 2001) M. A. Feeney and E. T. Corn. Method and Apparatus for Processing a Freehand Sketch. U.S. Pat. No. 6,233,351 B1. May 15, 2001.
(Tremblay 2009) C. J. Tremblay, P. Bécheiraz et. al. Sketch Recognition and Enhancement. U.S. Pat. No. 7,515,752 B2. Apr. 7, 2009.
(Ramani 2006) K. Ramani and J. Pu. Sketch Beautification. United States Patent Application Publication No. US 2006/0227140 A1. Oct. 12, 2006.
(Yamada 1991) H. Yamada, K. Yamamoto and T. Saito. Image Recognition System. U.S. Pat. No. 5,033,099. Jul. 16, 1991.
(Guha 2002) A. Guha. Feature Extraction for Real-Time Pattern Recognition using Single Curve per Pattern Analysis. United States Patent Application Publication US 2002/0097910 A1. Jul. 25, 2002.
(Yu 2004) Q. Yu and J. Luo. Petite Size Image Processing Engine. U.S. Pat. No. 6,804,418 B1. Oct. 12, 2004.
(Lipscomb 1991) J. S. Lipscomb. Multi-Scale Recognizer for Hand Drawn Strokes. U.S. Pat. No. 5,038,382. Aug. 6, 1991.
(SketchBoard 2013) Sketch Board Sketch Recognition. http://sketchboard.sourceforge.net/. Apr. 3, 2013.
(Scan2Cad 2013) Scan2Cad by Avia. www.scan2cad.com. Apr. 3, 2013.
(Autotracer 2013) Autotracer.org. Converts Your Raster Images to Vector Graphics. www.autotracer.org. Apr. 3, 2013.
(OneNote 2010) OneNote 2010. office.microsoft.com/en-us/onenote/. Nov. 1, 2012.
(VisionObjects 2013) VisionObjects. www.visionobjects.com. Apr. 3, 2013.
(MathType 2013) MathType 6.9. Equations Everywhere and Anywhere. http://www.dessci.com/en/products/mathtype/. Apr. 3, 2013.
(Neuroph 2013) Neuroph OCR Handwriting Recognition. http://sourceforge.net/projects/hwrecogntool/?source=recommended. Apr. 3, 2013.
(CellWriter 2013) CellWriter. http://risujin.org/cellwriter/. Apr. 3, 2013.
(Lipi 2013) Lipi Toolkit 4.0. http://lipitk.sourceforge.net/lipi-toolkit.htm. Apr. 3, 2013.

### SUMMARY OF THE INVENTION

It is the objective of the invention to provide a novel system for recognition and representation of image sketches, one that mitigates the disadvantages of the sketch recognition systems proposed in the past, in particular with regards to an actual reduction to practice.

This invention implements a system for automatic recognition of human-assisted drawings, in a plurality of forms, be they hand-drawn on paper, marker board, with a stylus on a computer, made with a mouse, stylus, finger or other instrument on a personal computer, tablet computer, smart telephone or other medium.

The invention involves a software system for recognition and vector representation of graphical, textual and equation patterns from imagery content (sketches). The invention provides an apparatus comprising a graphical user interface (GUI), configured to accept the user input (both the sketch and the configuration settings), a recognition engine, configured to extract the patterns of choice from the sketch and return to the image logic through a standardized interface in the form of a master entity with a hierarchical structure, an image logic (database abstraction) module, configured to return the recognized vector objects to the GUI for display, store the recognized vector entities in a database, support querying of the state of each vector entity and pass all such entities to the vector graphics generator. This cycle-free architecture also has provisions for a vector graphics generator, configured to accept the vector entities from the image logic and generate a vector representation of the input sketch (an intermediate output), a database system (or its proxy), configured to store the recognized vector entities along with dictionaries capturing the categories of valid graphical symbols and words (specific to the language selected), an error correction functionality, wherein the recognized objects are propagated from the recognition engine back to the GUI for visualization, user acceptance or modification, and a play-back mechanism, enabled by substituting the user input with a pre-recorded log file storing the user's past actions. In terms of the dependency diagram, the architecture conceived does not contain any loops. This offers great value in terms of significantly expediting the process of confining the source of certain behavior (desired or undesired) to given modules.

In accordance with one aspect of the present invention, the image resulting from this drawing, with input from the user, as to the category of the image, is analyzed by the described recognition algorithms to produce a resultant electronic image containing an idealized¹ vector representation of the intended image entered for processing. The algorithms for the graphics recognition include a method for automatically assessing whether the input image is a true color or a grayscale image, a procedure for edge detection, introduced as a means for bringing out the contours of filled graphical objects (for ease of identification of the contours of such objects), as well as a method for automatic identification and corrosion of ‘arrow-like’ or ‘T-like’ structures (accounting for rotation if necessary), for the purpose of separating the connectors from the graphical objects of interest. The recognition algorithms also feature a method for automatic identification of graphical objects in a grayscale image through a flood filling operation, combined with appropriate pre- and post-processing (erosion and dilation), a method for automatic identification of graphical objects in a grayscale image through contour search, a procedure for combining candidate objects extracted from flood filling with those obtained from direct contour identification, plus a procedure for automatically flagging ambiguity detections (i.e., small graphical objects that might correspond to text symbols). ¹ Lines are straightened, geometric objects are shown with the correct shape and proportion, objects are aligned, etc.

In accordance with another aspect of the present invention, a procedure is presented for separating the graphical objects, in particular the unidentified objects (the ones whose shapes does not conform with the predefined templates), from the connectors. The method relies on the population of a histogram for the ambiguity detections as well as another histogram capturing the ambiguity detections, connectors and the unidentified objects. A conservative estimate for a natural size metric in the image, corresponding to the most common size of the text symbols, is derived from the first histogram. This estimate is then applied to the latter histogram, for the purpose of isolating the large objects (the candidates for the unidentified objects).

In accordance with another aspect of the present invention, a hierarchical paradigm (standardized application program interface) is presented, that not only stores the graphical objects, text symbols, equations and interconnects recognized, in vector format, but also allows for extraction of valuable information, based on the relationships exhibited, as well as the creation of derivative structures, harnessing the relationships implied by the graphical objects, text symbols and equations used. More specifically, the invention provides means for extracting and interpreting the association between the graphical objects and the equations, between the graphical objects and the text objects, and between the text and the equation objects. The associations are captured in the hierarchical master entity passed from the pattern recognition engine to the image logic through the standardized application program interface.

Other aspects and features of the present invention will be readily apparent to those skilled in the art from reviewing the detailed description of the preferred embodiments in conjunction with the accompanying drawings.

The invention presents 20 primary use cases for mining the recognized patterns and making assessments based on the content. The present invention is not restricted to these embodiments. Variations can be made therein without departing from the scope of the invention.

### DESCRIPTION OF THE DRAWINGS

FIG. 1 captures the dependency diagram for the overall system architecture, for a preferred embodiment of the invention, at a high level.

FIG. 2 defines the dependency relationships employed in FIG. 1. The caller, which is the initiator of the request, depends on the callee, which responds to the call.

FIG. 3 captures the sequence diagram for a typical use case of the pattern recognition engine. The sequence of actions behind the typical use case are numbered in order and associated with the arrow interconnecting the modules that are handling the actions.

FIG. 4 specifies the primary graphical objects supported by the pattern recognition engine. The category of unidentified object—not a connector—is excluded from the Figure. Additional objects can be included, without deviating from the scope of the present invention.

FIG. 5 captures the top hierarchy of the application program interface and class structure for the pattern recognition engine (items 105 and 309).

FIG. 6 further expands on the class structure of the rectangles, polygons, circles and triangles, and encapsulates their relationship with the associated text and equation objects.

FIG. 7A and FIG. 7B, similarly, expand on the class structure of the ellipsoid and unidentified objects, and formulate the relationship with the associated text and equation objects.

FIG. 7C, further, explains how a text object can be associated with a connector. FIG. 7D outlines the relationship between an equation, not associated with a primary graphical object, and the subordinate text object.

FIG. 8 captures the internal structure of the pattern recognition engine (items 105 and 309) at a reasonably high level. The vector representations of the graphical objects (item 821) are delivered to the Image Logic (items 106 and 311). The same applies to the vector representation of the ASCII text (item 813) and the Connectors (item 818). The Dictionary (item 817) corresponds to the same Dictionary as items 117 and 321.

FIG. 9 presents some of the primary intricacies of the method for extracting the graphical objects from the input image (item 802 in FIG. 8).

For the case when the gray values are included, FIG. 10 outlines the aspects of the color segmentation algorithm (item 915 in FIG. 9) associated with the splitting of the input image into the blue, green and red components.

FIG. 11A, FIG. 11C and FIG. 11E further expand on the color segmentation from FIG. 10 and explain how the higher and lower segmentation thresholds are determined adaptively, from the histograms for the blue, green and red components. FIG. 11B, FIG. 11D and FIG. 11F illustrate how individual components from the input image can be isolated (segmented out), based on the ranges defined by the higher and lower segmentation thresholds.

Similarly, for the case when the gray values are excluded, FIG. 12 outlines the aspects of the color segmentation algorithm (item 913 in FIG. 9) associated with the splitting of the input image into the blue, green and red components. The absence of the gray values helps in terms of separating the top of the water tank from the main support.

FIG. 13A, FIG. 13C and FIG. 13E further expand on the color segmentation from FIG. 12 and explains how the higher and lower segmentation thresholds are determined adaptively, from the histograms for the blue, green and red components, for the case when the gray values are excluded. FIG. 13B, FIG. 13D and FIG. 13F show how individual components from the input image can be isolated (segmented out). For the purpose of avoiding multiple detections, the objects identified through the original color segmentation (FIG. 11A-FIG. 11F) are compared and contrasted with the ones extracted from the color segmentation with the gray values excluded (see item 921 in FIG. 9).

FIG. 14A and FIG. 14B provide a schematic illustration of how an histogram for the connectors, ambiguity detections and unidentified objects can be used, in conjunction with a histogram for the ambiguity detections only, to determine the adaptive threshold (a natural length scale in the image corresponding to the most common size of the text symbols) along with the primary candidates for the unidentified objects.

FIG. 15 offers a simple illustration of the association of a text object with a graphical object, the association of an equation with a graphical object, and the association of a text object with an equation object.

FIG. 16 captures the application of the invention to one of the primary use cases of interest (engineering design processes). Items 1610-1626 reflect the structure of the mining and assessment engine for this particular use case. Items 1600-1609 and 1627-1636 capture the pattern recognition engine. The thick line between items 1609 and 1610 separates these two engines. The steps corresponding to items 1601-1609 are further articulated in FIG. 8.

### DETAILED DESCRIPTION OF THE PREFERRED EMBODIMENTS

The user input is a sketch, a draft, a plan, or another type of preliminary drawing comprised of text (typed, handwritten or entered directly into a computer, tablet, smartphone or other device); of graphic elements (boxes, geometric shapes, interconnecting lines and arrows); of mathematical formulas or equations; chemical formulas or equations; or of other graphical representations of objects (e.g. piping, valves, or other elements which may be represented by a symbol).

### 1. DEFINITIONS

Image sketch, as used herein, shall mean an accurate or approximate drawing or representation of an image. Table 1 captures the primary definitions and acronyms used in the patent.

TABLE 1
Summary of the primary definitions and acronyms.

| Name | Definition |
|---|---|
| 2D | An acronym for Two-Dimensional |
| 3D | An acronym for Three-Dimensional |
| API | An acronym for Application Programming Interface |
| CAD | An acronym for Computer Aided Design |
| GUI | An acronym for Graphical User Interface |
| I/O | An acronym for Input/Output |
| MS | An acronym for the name MicroSoft |
| PC | An acronym for Personal Computer |
| PDF | An acronym for Portable Document Format |
| Sketch | An approximate drawing or representation |
| SVG | An acronym for Scalable Vector Graphics |
| XML | An acronym for eXtensible Mark-up Language |

### 2. BEST MODE OF THE INVENTION

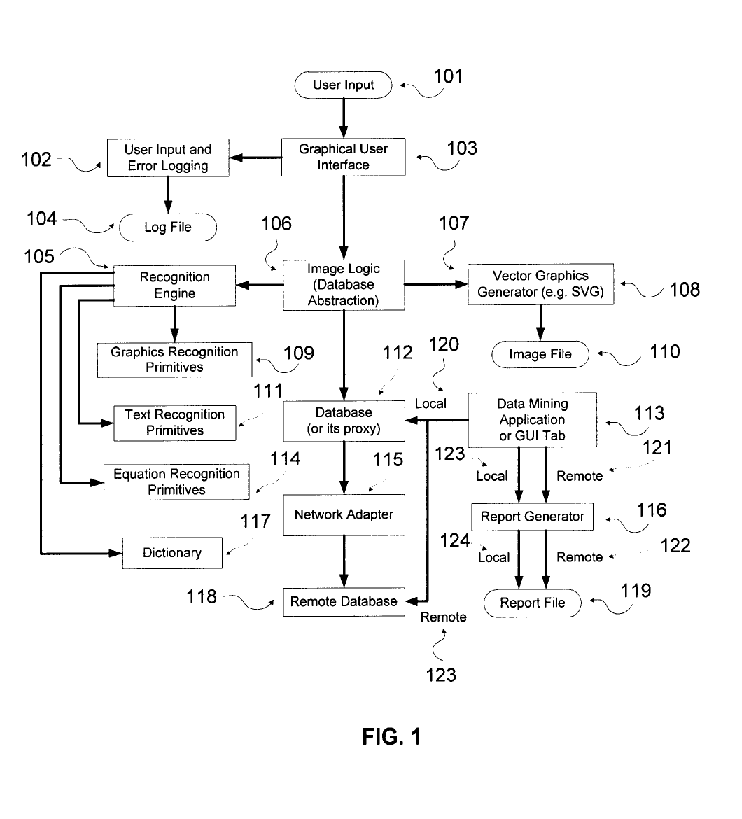

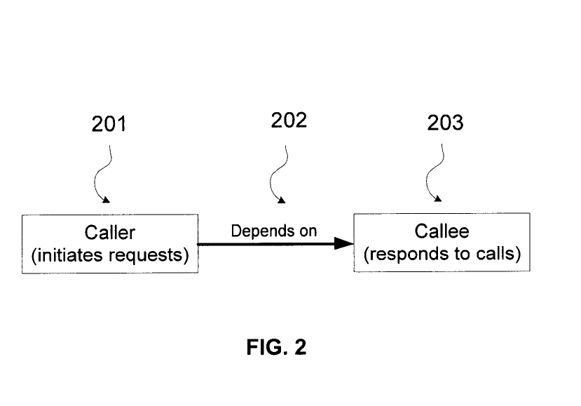

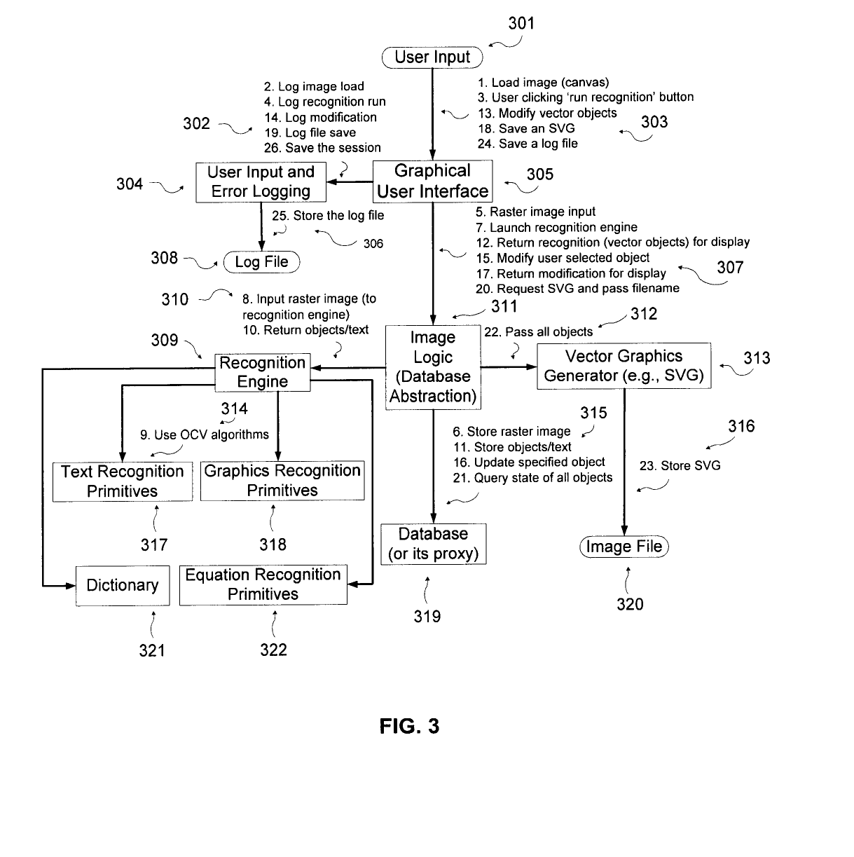

FIG. 1 and FIG. 3 show dependency diagrams for the best mode contemplated by the inventors for automatically recognizing and representing the imagery content, according to the concepts of the present invention. FIG. 2 defines the nature of the dependency relation.

### 3. HOW TO MAKE THE INVENTION

The apparatus for the automatic image recognition and representation is realized through programming of a desktop, laptop, tablet PCs, smartphones or other computing devices running Windows, Linux, iOS, Android or a similar operating system. FIG. 1 and FIG. 3 present a dependency diagram of the primary modules comprising the invention. The ensuing sections expand on the software modules and API needed for the realization of the invention.

### Inputs

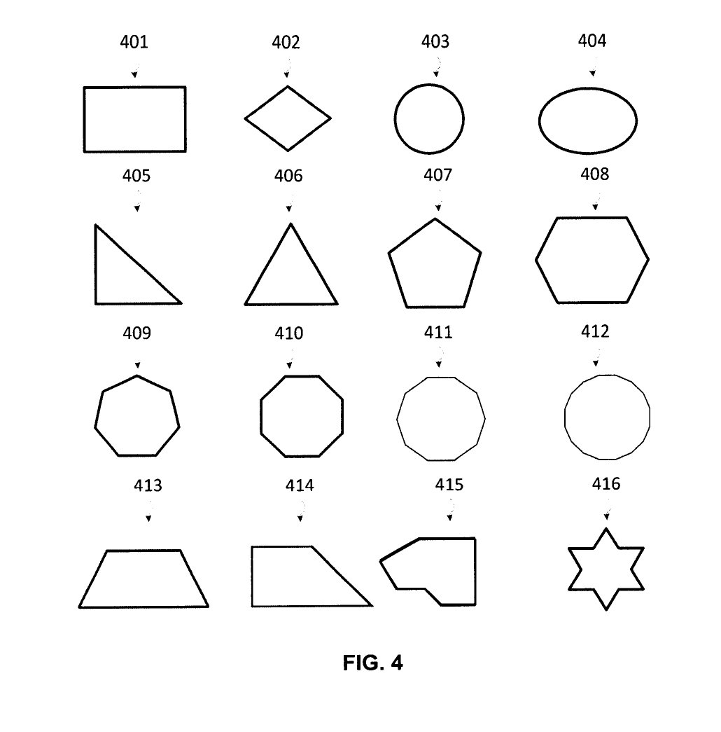

The apparatus for automatic recognition and representation of the image sketches accepts as input
1. Scans, snapshots or direct entry of image sketches.
   The scans and snapshots are assumed to be in color, and might be stored as bitmaps or in .pdf format.
   It is assumed the image contains sufficient resolution for accurate identification (at least 200 dpi).
2. Information pertaining to the categories of the graphical objects to be identified, the language to whose words the recognized text should be mapped as well as the type of equation to be recognized.
   The apparatus presents a pre-defined set of categories corresponding to the supported use cases. The application is not limited to the supported use cases (they are intended to serve as examples). The application may be applied to other use cases as well, as long as the symbol shapes and their relationships can be specified.
   FIG. 4 presents samples of the graphical objects supported. Additional symbols can be substantiated without deviating from the scope of the invention.

### Outputs

The apparatus for automatic image recognition and representation returns as output
1. A vector graphics file capturing the vector representation of the image sketch.
   This includes the graphical objects, the handwritten text and the equations recognized.
   One embodiment of the invention assumes the output files comply with the Scalable Vector Graphics (SVG) format.
   Other vector graphics formats can be used without deviating from the scope of the invention.
2. Supplementary information, such as the number of the graphical objects and words recognized, or the sub-categories to which the recognized objects and words belong.
   The sub-categories are derived from the primary categories (which are selected by the user).

SVG is a family of XML specifications for two-dimensional vector graphics, both static and dynamic (interactive). It is an open file format and has been recognized as being quite stable and well established. The text, graphics and equations, in .SVG format, may be automatically loaded into applications such as Microsoft Visio, Word or Powerpoint, into open-source applications, such as the LibreOffice Draw, or into a web browser (Internet Explorer, Google Chrome or Firefox).

### Master Architecture

FIG. 1 represents a dependency diagram for the master architecture. This is not a chart showing the flow of data through the system. Or more specifically, the software system for the recognition engine (item 105) can exist (i.e., can be built and run) without the image logic (item 106) or the graphical user interface (item 103) being present. The pattern recognition engine can conduct its job flawlessly, for that matter, without knowing about the existence of the GUI. However, the image logic cannot deliver the data structures capturing the vector representation of the input image, without support from the recognition engine. The pattern recognition engine can exist without the image logic (or the GUI), but the image logic cannot do its job without the pattern recognition engine providing the recognized structures.

The dependency diagram was artfully crafted such that it did not contain any cyclic dependencies. This helps greatly in terms of locating defects (bugs) within the software architecture. With cyclic patterns present in the architecture, bugs can be hard to track down due to propagation of the symptoms through the system.

### Graphical User Interface 103

The GUI is assumed to be based on the traditional Model-View-Controller model. For desktop and laptop applications, a relatively simple, MS Office-like GUI may suffice.

### In-Memory Database 112

The in-memory database stores the vector representations of all the objects in the image, upon completion of the graphics, text and equation recognition, and before conversion into the SVG format. The in-memory database also stores the finite set of objects or words that the pattern recognition application is looking for in the image (see item 117 in FIG. 1, labeled ‘Dictionary’). It is of paramount importance that the database supports an in-memory mode. Graphics recognition applications typically require millions of comparative operations. Without the in-memory mode, every comparison would require an I/O call. This would introduce significant latency.

### Image Logic 106

The image logic serves as an interface, or abstraction layer, to the in-memory database. This provides a pathway for starting out with simple storage, based on internal data structures, if desired, and later incorporating database storage. The image logic receives text descriptors for the recognized objects, text and equations from the recognition engine and passes along to the vector graphics generator, or to the GUI (for updating the canvas).

### Vector Graphics Generator 108

TeX sets the standard for elegant vector representations of text, graphics and equations. LaTeX and MikTeX output postscript files capturing the vector structures. The SVG files can store text, as long as it is vector formatted. From the perspective of the GUI, text is more than plain ASCII code. Once the text has been properly cast into a vector format, you can magnify the text arbitrarily without it becoming pixilated. Upon the pattern recognition engine identifying the ASCII characters comprising certain handwriting samples, the text is added to a text tag of the SVG file along with appropriate font and rendering information. Similarly, equations represent another set of text-like symbols. Once the equation recognition algorithms have decomposed a given equation, and identified the constituent symbols, one can store the symbols as text in a similar fashion.

### Play-Back Mechanism

The architecture in FIG. 1 contains implicit support for playing back and reproducing the user actions. To activate the play-back mechanism, one simply needs to substitute the User Input (item 101 and 301) with the Log File (item 104 and 308).

### Prelude to the Graphics Recognition 109

The graphics recognition primitives might be based on the OpenCV computer vision library. The Dictionary (item 117 and 321) stores the type (category) of the graphical objects supported by the recognition engine, a sample of which is presented in FIG. 4, as well as the sub-categories to which the counted words are mapped. The user specifies the types of the objects to be recognized.

### Prelude to the Handwriting Recognition 111

Similarly, the Dictionary (item 117 and 321) stores the languages supported by the handwriting recognition, as well as the categories of words supported by the language chosen. While the handwriting recognition could support multiple dictionaries, separate for each language, items 117 and 321 are intended to represent them all. It is up to the user to specify the language to which the recognized words are mapped.

### Prelude to the Equation Recognition 114

The user would also specify the categories of equations to be identified (mathematical equations, chemical equations, etc.). The Dictionary (item 117 and 321) stores the supported equation types. Both sub-scripts and super-scripts are supported.

### Class Diagram and API for the Pattern Recognition Engine

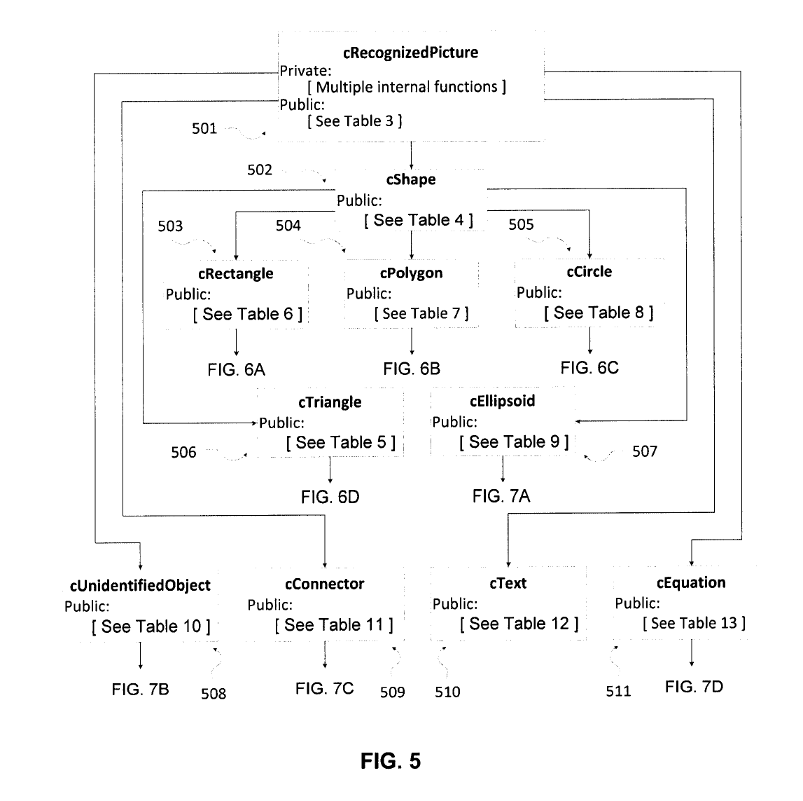

The apparatus for the automatic recognition and representation specifies, in FIG. 5 and Table 3-Table 13, a convenient form of vector (string) descriptors capturing the representation of the graphical objects, connectors, text and equations, through inheritance relationships. These store the vector parameters for the recognized objects: the row and column positions of the center, the object identifier, size parameters, rotation angle, etc. This is complete set of information needed for rendering the recognized objects. Once we have established the types (classes) of the recognized objects, we put the vector information about the objects in a tag, specific to these types, and store in the SVG file.

The image logic calls the recognition engine, through a call of the form

c_Recognized_Patterns.Find_Image_Patterns( IMPORTED_IMAGE,

VectorizedObjectsConnectors,
&a_iNumberVerifiedGraphicalObjects,
Pixel_Map_Text_Recognition );

Here
c_Recognized_Patterns
   is the C++ master object that all the recognized patterns are appended to. The image logic receives back, not only the vector representations of the graphical objects, text and equations recognized, but also the character array pcErrorMessage[ ]. If some type of problems are identified during the recognition process, pcErrorMessage[ ] stores the information about the nature of the problems observed. Table 2 lists samples of the error messages that the API could support.

By creating a small and well-defined API for the pattern recognition engine, the invention realizes an apparatus that is modular in structure and relatively easy to debug (no hodge-podge design). Small APIs allow one to confine the software bugs to given modules. The well-defined API enables developers of other system modules to easily and efficiently comprehend what the pattern recognition module expects as an input, what it provides as an output, and what type of error messages it supports (no confusion). These developers do not need to concern themselves with all the intricacies of the pattern recognition engine, but can instead focus on their primary tasks at hand.

TABLE 2
Error messages supported by the API for the pattern recognition. Additional error
messages can be included without deviating from the scope of the present invention.

| Error Message | Scenario that Could Give Rise to the Message |
|---|---|
| None | No error identified |
| Invalid image color | White drawing on mostly black background |
| Insufficient image resolution | Rectangles and circles are only several pixels wide/thick |
| Image not sharp enough | Lines are blurred due to poor lighting conditions or poor |
| | settings of the imaging sensor |
| Unrecognized text | We can recognize object as text, but can't recognize the |
| | individual characters (could occur for bad handwriting or |
| | characters from a foreign language) |
| Image intensity is too low | The graphics recognition may fail if black color is cast as light- |
| | grey due to poor lighting conditions or camera settings |
| Shapes are in an unexpected | Objects could overlap; an arrow could lead to empty space |
| logical position | |

TABLE 3
Private data structures defined for the class cRecognizedPicture.

| Data Structure | Type | Explanation |
|---|---|---|
| Find_ Image_ Patterns ( ) | void | Master function |
| pcErrorMessage | vector <char> | Error message |
| pstVerifiedRectangles | vector <cRectangle> | Vector of verified |
| | | rectangles |
| pstVerifiedCircles | vector <cCircles> | Vector of verified |
| | | circles |
| pstVerifiedPolygons | vector <cPolygons> | Vector of verified |
| | | Polygons |
| pstVerifiedEllipsoids | vector <cEllipsoids> | Vector of verified |
| | | ellipsoids |
| pstVerifiedConnectors | vector | Vector of verified |
| | <stConnectors> | connectors |
| pstUnidentified- | vector | Vector of unidentified |
| Objects | <stUnidentified> | objects verified |

TABLE 4
Public data structures defined for the class cShape.

| Data Structure | Type | Explanation |
|---|---|---|
| bFilled | bool | Specifies if the object is |
| | | filled |
| bIsEmpty | int | Specifies if the object con- |
| | | tains other objects or not |
| iObjectID | int | Global object identifier |
| iMinXboundingRect | int | Min. x component of the |
| | | bounding rectangle |
| iMaxXboundingRect | int | Max. x component of the |
| | | bounding rectangle |
| iMinYboundingRect | int | Min. y component of the |
| | | bounding rectangle |
| iMaxYboundingRect | int | Max. y component of the |
| | | bounding rectangle |
| pucLineColorRGB [3] | unsigned char | Red, green and blue com- |
| | | ponents of enclosing line |
| pucFillColorRGB [3] | unsigned char | Red, green and blue com- |
| | | ponents of the filling color |
| pstVerifiedConnectors | vector | Vector of pointers to the |
| | <stConnectors *> | connecting connectors |
| pclConnectedObjects | vector <cShape *> | Vector of pointers |
| | | to the object connecting |
| | | to the current object |
| pclAdjacentObjects | vector <cShape * > | Vector of pointers to |
| | | the objects adjacent to |
| | | the current objects |
| pclInsideObjects | vector <cShape *> | Vector of pointers |
| | | to the objects inside |
| | | the current object |

TABLE 5
Public data structures defined for the class cTriangle.

| Data Structure | Type | Explanation |
|---|---|---|
| pstCornerPoints [3] | stPointI | The (x,v) coordinates of the 3 |
| | | corner points of fitted triangle |
| fDegreeOfRectangleness | float | Degree of resemblance of original |
| | | object with an ideal triangle |

TABLE 6
Public data structures defined for class cRectangle.

| Data Structure | Type | Explanation |
|---|---|---|
| pstCornerPoints [4] | stPointI | The (x,y) coordinates of the 4 |
| | | corner points of fitted rectangle |
| stCenter | stPointI | The (x,y) coordinates of the center |
| | | of the fitted rectangle |
| iWidth | int | The width in pixels |
| iHeight | int | The height in pixels |
| fAngle | float | Angle of the rotated rectangle |
| fDegreeOfRectangleness | float | Degree of resemblance of original |
| | | object with an ideal rectangle |
| ucAmbiguityDetection | unsigned char | Is the rectangle a suspected |
| | | ambiguity detection? |

TABLE 7
Public data structures defined for class cPolygon.

| Data Structure | Type | Explanation |
|---|---|---|
| stCornerPoints | vector | The (x,y) coordinates of the corner |
| | <stPointI> | points of the polygon |
| stMassCenter | stPointI | The (x,y) coordinates of the center |
| | | point of the polygon |
| iPolygonMismatch | int | The degree of mismatch of the |
| | | object with an ideal polygon |

TABLE 8
Public data structures defined for class cCircle.

| Data Structure | Type | Explanation |
|---|---|---|
| stCenter | stPointI | The (x,y) coordinates of the center |
| | | point of the circle |
| fRadius | float | The radius of the circle |
| fDegreeOfCircularity | float | Degree of resemblance of original |
| | | object with an ideal circle |
| ucAmbiguityDetection | unsigned char | Is the circle a suspected ambiguity |
| | | detection? |

TABLE 9
Public data structures defined for class cEllipsoid.

| Data Structure | Type | Explanation |
|---|---|---|
| stCenter | stPointI | The (x,y) coordinates of the center |
| iHeight | int | Height of the ellipsoid |
| iWidth | int | Width of the ellipsoid |
| fAngle | float | Rotation angle of the ellipsoid |
| ucAmbiguityDetection | unsigned char | Is the ellipsoid a suspected |
| | | ambiguity detection? |

TABLE 10
Public data structures defined for class cUnidentifiedObject.

| Data Structure | Type | Explanation |
|---|---|---|
| stContourPoints | vector | The (x,y) coordinates of the contour |
| | <stPointI> | points comprising the object |
| iHeightBoundingBox | int | Height of the enclosing bounding box |
| iLengthBoundingBox | int | Length of the bounding box |
| iIndxLeftMostPoint | int | Index of the contour point with the |
| | | smallest value of the horizontal |
| | | coordinate |
| iIndxRightMostPoint | int | Index of the contour point with the |
| | | largest value of the horizontal |
| | | coordinate |
| iIndxTopMostPoint | int | Index of the contour point with the |
| | | smallest value of the vertical coordinate |
| iIndxBottomMostPoint | int | Index of the contour point with the |
| | | largest value of the vertical coordinate |

TABLE 11
Public data structures defined for class cConnector.

| Data Structure | Type | Explanation |
|---|---|---|
| stContourPoints | vector | The (x,y) coordinates of the contour |
| | <stPointI> | points comprising the object |
| iHeightBoundingBox | int | Height of the bounding box enclosing |
| | | the unidentified object (width of arrow) |
| iLengthBoundingBox | int | Length of the bounding box (arrow) |
| iIndxLeftMostPoint | int | Index of the contour point with the |
| | | smallest value of the horizontal |
| | | coordinate |
| iIndxRightMostPoint | int | Index of the contour point with the |
| | | largest value of the |
| | | horizontal coordinate |
| iIndxTopMostPoint | int | Index of the contour point with the |
| | | smallest value of the vertical coordinate |
| iIndxBottomMostPoint | int | Index of the contour point with the |
| | | largest value of the vertical coordinate |
| pclObjStart | cShape * | Pointer to the object from which the |
| | | connector emanates |
| pObjEnd | cShape * | Pointer to the object to which the |
| | | connector emanates |
| iCategory | int | ID specifying the connector category |

TABLE 12
Public data structures defined for class cText.

| Data Structure | Type | Explanation |
|---|---|---|
| iObjectID | int | Global object identifier |
| iParentObjectID | int | Identifier of the parent object |
| eFont Type | enum | Specification of the font type |
| ucFontSize | unsigned char | Specification of the font size |
| piFontColorRGB[3] | 3-element | Specification of the font color (the red, |
| | vector of int's | green and blue components) |
| stCenter | stPointI | Center point of the text object |
| pucAsciiText | Vector of | ASCII letters of the recognized text |
| | unsigned char | |

[Other formatting details omitted]

TABLE 13
Public data structures defined for class cEquation.

| Data Structure | Type | Explanation |
|---|---|---|
| iObject ID | Int | Global object identifier |
| iParentObjectID | int | Identifier of the parent object |
| eFontType | enum | Specification of the font type |
| ucFontSize | unsigned char | Specification of the nominal |
| | | font size |
| piFontColorRGB [3] | 3-element | Specification of the font color (the |
| | vector of int's | red, green and blue components) |
| stCenter | stPointI | Center point of the equation object |
| pucAsciiText | vector | ASCII letters comprising the |
| | <unsigned char> | recognized equation |

[Other formatting details omitted]

The structure stPointI is simply defined as

| | |
|---|---|
| struct stPointI | |
| { | |
| int x; | (1) |
| int y; | |
| }; | |

### High-Level Structure of the Pattern Recognition Engine

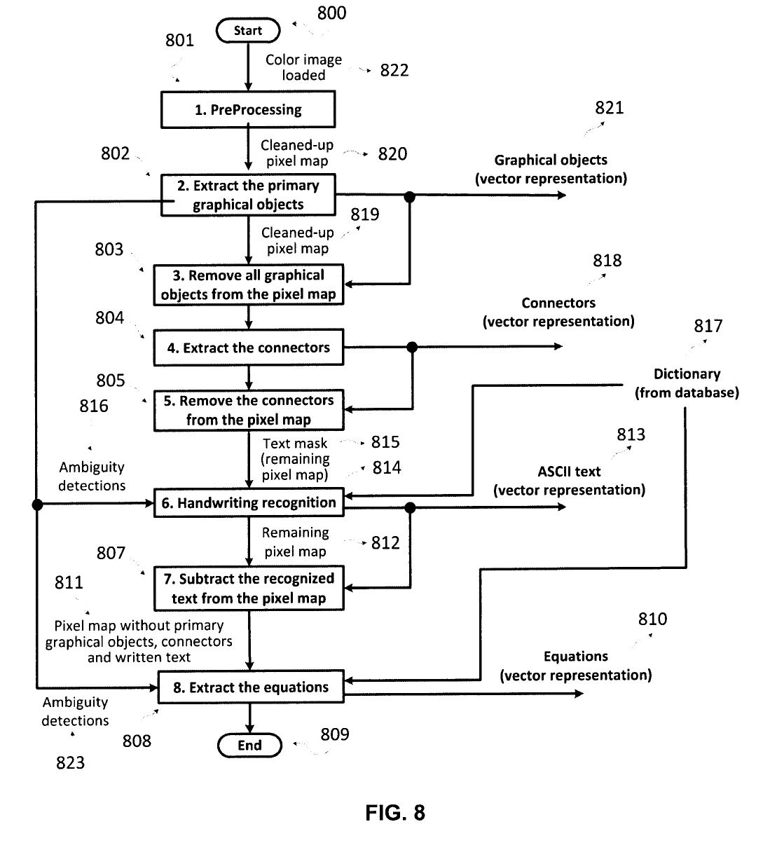

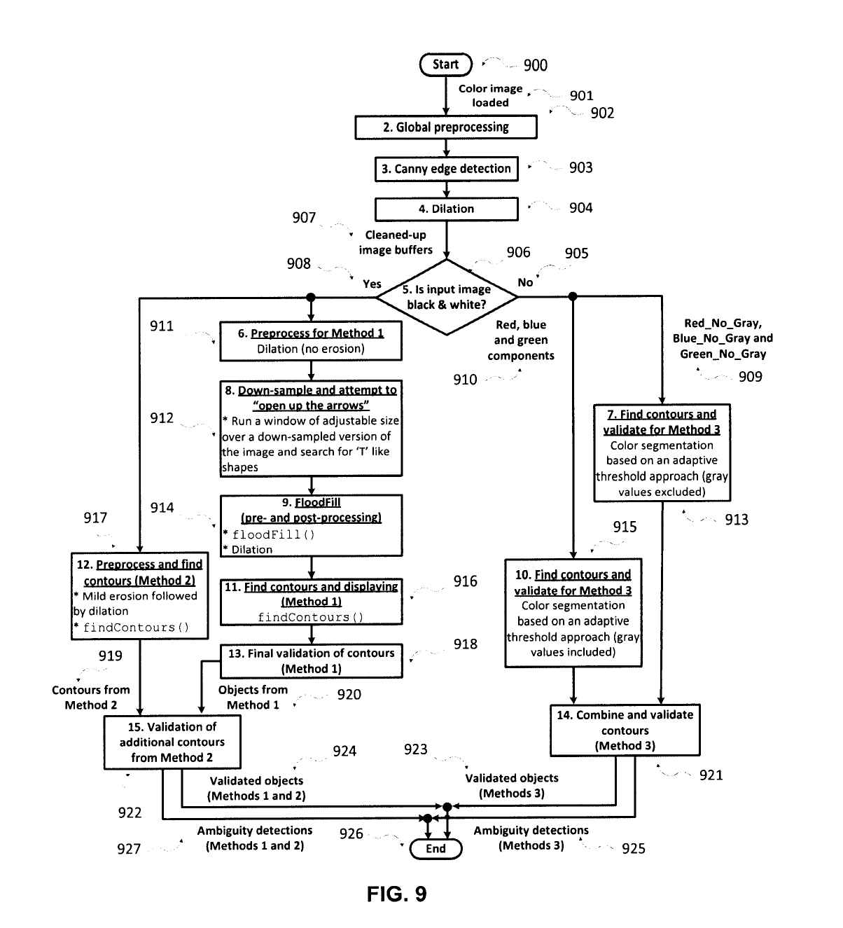

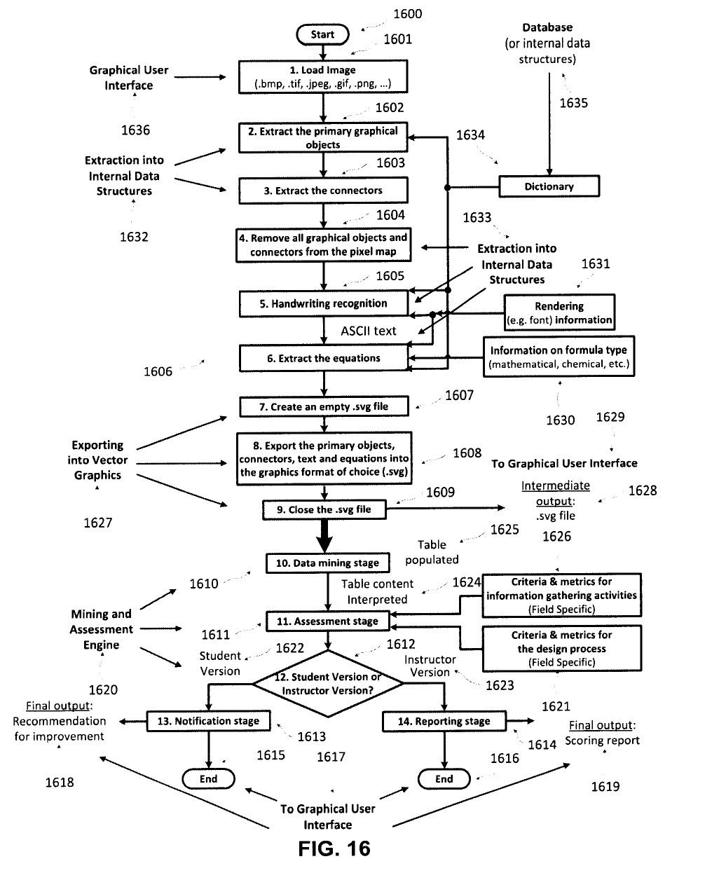

This Section expands on items 803-808 in FIG. 8. In terms of inputs and outputs, FIG. 8 is consistent with FIG. 1, FIG. 3, FIG. 8 and FIG. 16. The recognition of the ‘primary graphical objects’ is specifically addressed through FIG. 9-FIG. 13. A ‘primary graphical object’ refers to a distinct, true object in the input image, corresponding to one of the primary classes in FIG. 5 (a triangle, rectangle, polygon, ellipsoid, a circle or an unidentified object) or one of the symbols in FIG. 4. A ‘graphical object’ can correspond to any object in the input image, recognized as a graphical object. This includes the ‘ambiguity detections’, i.e., the text symbols, say the ‘O’s or ‘o’s that may have been detected as graphical objects (circles or ellipsoids). Similarly, a thick, broken connector can be confused with a text symbol (‘l’) or even with a small rectangle.

### Extracting the Connectors and Unidentified Objects

With the primary graphical objects accurately identified, extracting the connectors, text symbols and unidentified objects (item 804 in FIG. 8) is not too difficult. One can simply erase the sections of the original image overlapping with the contours extracted from the graphical objects. With the primary graphical objects removed, one can extract the contours for the object candidates remaining, for example by applying the findContours( ) function:

findContours( FOREGR_BUFFER, contoursConnectors, hierarchy,

CV_RETR_TREE, CV_CHAIN_APPROX_SIMPLE,
Point(0, 0) );

Often, these contours tend to be relatively ‘clean’, i.e., properly confined to the connectors of interest, since—with the graphical objects removed—there may be no direct paths in the image for ‘connecting the connectors’.

Separating the Text from the Graphical Objects and Recognizing

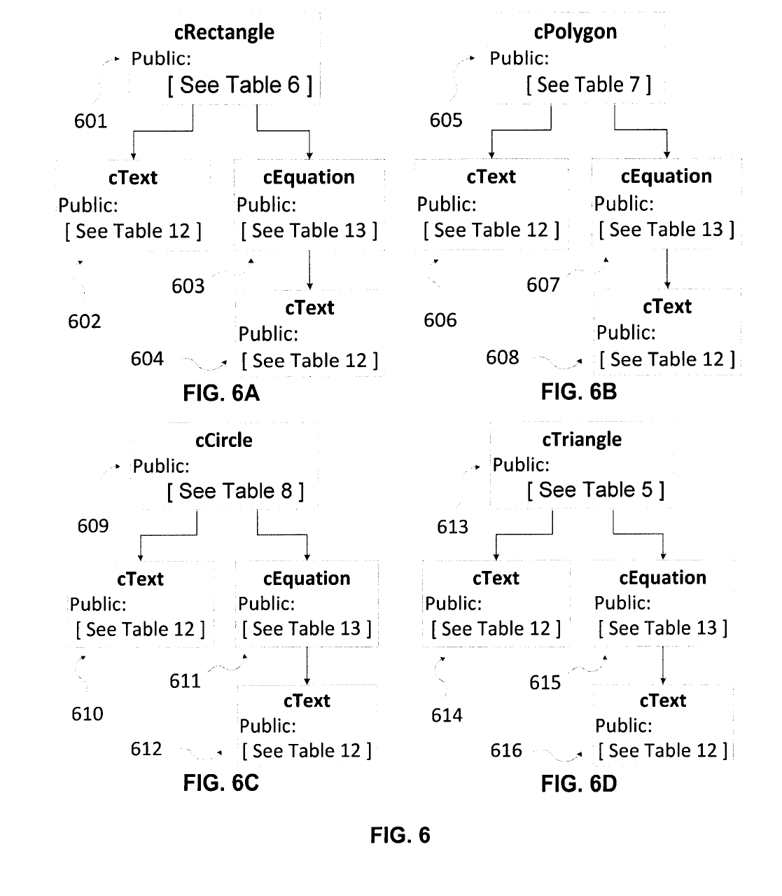

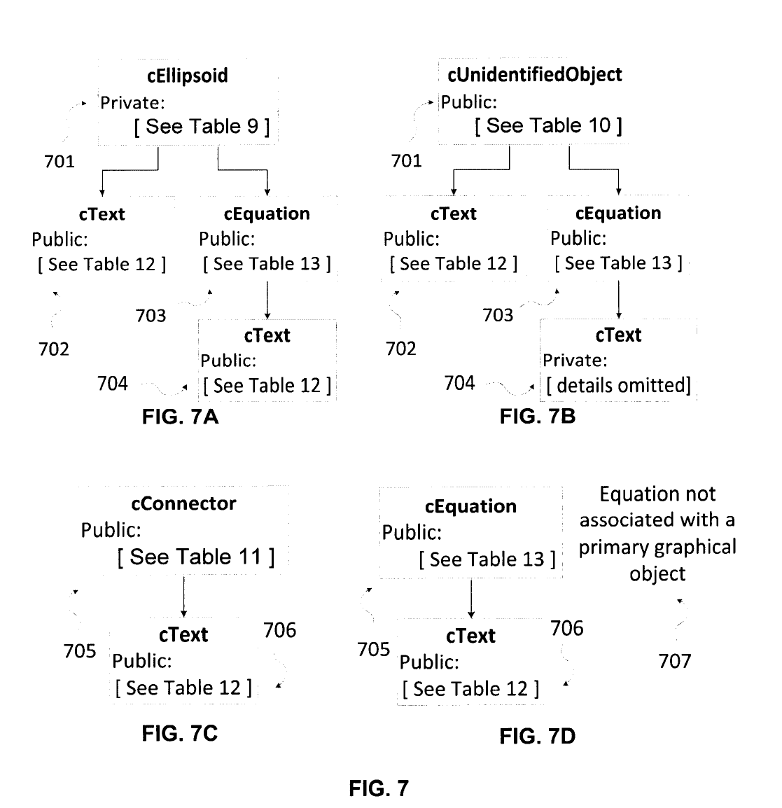

Once the primary graphical objects, including the unidentified ones, and the associated connectors have been recognized, these can be erased from the original image. The handwriting recognition is applied to the resulting image. Whereas this procedure may seem straight forward in principle, practical implementations can impose challenges, because in practice, the graphics and text recognition are inter-related. Further, accurate identification of connectors vs. unrecognized objects can be far from trivial. One, for example, needs to ensure during the graphics recognition stage that the ‘o’s are not recognized as circles and the ‘l’s not as line segments. To resolve such conflicts, ‘ambiguity detections’ (items 816 and 823 in FIG. 8) were introduced, as noted above, along with constraints pertaining to the object size, adjacency and degree of alignment on a straight line pattern. The apparatus assumes a distinct color (such medium-dark gray, corresponding to the 8-bit red value of 100, the 8-bit green value of 100 and the 8-bit blue value of 100) has been reserved for the ambiguity detections. Correct separation of the text and the graphics is vital for the overall process. The cText class in FIG. 6 and FIG. 7 stores the ASCII letters for the recognized text in the vector pucAsciiText[ ] (see Table 12).

Separating the Equations from the Text and Recognizing

While in principle, equations can be recognized through identification of ‘primary separators, i.e., specialized symbols, such as ‘=’, ‘≧’, ‘≦’, ‘≈’, ‘≠’, ‘<’, ‘>’, and ‘≡’ and the equation recognition (item 808 in FIG. 8) exhibits dependency on the text recognition in practice (just as the text recognition depends on the graphics recognition).

At a high level, the equation recognition is founded on the following, primary steps:
1. Identification of the ‘primary separators’ (in particular, ‘=’, ‘≧’, ‘≦’, ‘≈’, ‘≠’, ‘<’, ‘>’, and ‘≡’).
2. Partitioning the equation into a left side′ and a ‘right side’, once the ‘primary separators’ have been identified.
3. Now separately partitioning the left side′ and the ‘right side’ further: Look for the ‘secondary separators’, i.e., symbols such as ‘+’, ‘−’, ‘*’ and ‘/’.
4. Identifying through this process the ‘constituent symbols’, i.e., the smallest equation primitives.
5. Carrying out ‘text-like’ recognition on the ‘constituent symbols’.
6. Reassembling the recognized equation primitives (‘constituent symbols’) into a complete equation.

This approach works for recognizing equations, such as arithmetic formulas, that adhere to regular line structure. Advanced mathematical formulas and chemical equations are much more complicated, since here the symbols may be positioned to the top of, below, to the left of, or to the right of one another. Here, one cannot rely on adherence to a straight line.

### Recognition of the Graphical Objects

This Section expands on the algorithms for preprocessing the input image and extracting the graphical objects (items 801 and 802 in FIG. 8). FIG. 9 presents a flow chart for the expanded algorithms. The primary focus is on the preprocessing steps as well as the algorithms designed to recognize the objects for the case of grayscale images. These algorithms are referred to as Method 1 and Method 2. The recognition of the graphical objects for the case of color images (Method 3) is further addressed in FIG. 10-FIG. 13. Note that FIG. 9 is consistent with items 801 and 802 from FIG. 8 in terms of the inputs and the outputs. The input is the loaded color image. The output consists of the verified graphical objects as well as the ambiguity detections.

### Preprocessing: Automatic Method for Identifying True Color Images

During the scan over the input image, for splitting it into the red, green and blue color components, the method computes the number of pixels for which the 8-bit red, green and blue components differ by more than a fixed number of intensity levels:

| | |
|---|---|
| if( (abs(b − r) > MIN_GRAY_LEVELS) | \|\| (abs(r − g) > MIN_GRAY_LEVELS) |
| | \|\| (abs(b − g) > MIN_GRAY_LEVELS) ) |
| | a_iCntrColorPixels++; |

Here, typically,

MIN_GRAY_LEVELSε[10,20]. (2)

and

a,b,cε[0,256]. (3)

If at least 1% of the image pixels are true color pixels, per the definition above, the image is declared a true color image:

| | | |
|---|---|---|
| if( a_iCntrColorPixels * 100 | > IMPORTED_IMAGE.rows * | |
| | IMPORTED_IMAGE.cols ) ) | (4) |
| | g_iInputImageIsBlackAndWhite = 0; | |

### Other Preprocessing Steps

The other preprocessing steps include splitting the input image into the red, blue and green components, producing separate red, blue and green buffers with the gray components excluded, as well as of conducting the error checks listed in Table 2.

### Philosophy Behind Methods 1 and 2

Methods 1 and 2 were designed with a conservative approach in mind. It is of paramount importance that neither Method 1 nor Method 2 produce false detections. However, neither method needs to detect all the objects in the image, as long as together they manage to detect all the objects.

### Specifics of Method 1

Method 1 attempts to identify the contours by applying a flood filling operation, followed by a search for the contours within the filled image:

floodFill( PREPROCESSED_IMAGE, seed, brightness, &ccomp,

Scalar(lo,lo,lo), Scalar(up,up,up), flags );

findContours( FOREGR_BUFFER, contoursFloodFill, hierarchy,
CV_RETR_TREE, CV_CHAIN_APPROX_SIMPLE, Point(0, 0) );

Here PREPROCESSED_IMAGE corresponds to the preprocessed image after down sampling by factor 4 and an attempt to “open up the arrows”, or specifically to the input to Step 9 in FIG. 9. We “open up the arrows” in Step 8 by running a relatively small window of, size

Vertical_window_size=Number_of_rows_in_image/192 (5)

Horizontal_window_size=Number_of_columns_in_image/160 (6)

over the image and looking for line segments that extend over the entire window, either horizontally or vertically, and intersect with a diagonally oriented line segment that extends only partially over the window. The diagonally oriented line, which can be thought of as corresponding to the leg of a ‘T’ shaped structure, is partially erased from the preprocessed buffer. In the function call above, FOREGR_BUFFER is a binarized (and inverted) version of the PREPROCESSED_IMAGE buffer containing 8-bit values. Alternative window dimensions can be specified, without deviating from the scope of this invention.

The procedure from [0084] works well for images with relatively few cyclic patterns (loops). Following the flood filling and the contour search, there might be a fairly aggressive erosion operation whose purpose could be to erase the connectors from the working copy of the foreground buffer:
erode(FOREGR_BUFFER, FOREGR_BUFFER, element);

Assuming the primary graphical objects of interest have been properly filled, there is little chance of them disappearing. Next, the resulting contours are validated. The following, primary steps comprise the contour validation process:
1. Determine the best-fit rectangle, ellipse, circle or a polygon to the current contour (contour no. i).
2. Determine the polygon, contours_polyFloodFill[i], offering a low-dimensional approximation to the shape of contour i (i.e., of contoursFloodFill[i]):
   approxPolyDP(Mat(contoursFloodFill[i]),contours_polyFloodFill[i], 0.02*arcLength(contoursFloodFill[i],true), true);
3. Measure the percentage of the area overlap. In case of the ellipsoids, the class variable
   fDegreeOfEllipsoidness
      is defined as

$$fDegreeOfEllipsoidness = 100 * \frac{Max\_Area - Area\_Difference}{Max\_Area} \qquad ( 7 )$$

### Here

Max_Area=max(area_of_contoursFloodFill[i],area_of_the_best_fit_ellipsoid) (8)

Area Difference=abs(area_of_contoursFloodFill[i]−area_of_the_best_fit_ellipsoid) (9)

The terms fDegreeOfCircularity and fDegreeOfRectangleness are defined in an analogous fashion.
4. Determine if the contour is convex:
   isContourConvex(contours_polyFloodFill[i])

Most of the graphical objects of interest consist of convex shapes.
5. Analyze the angles between points of the approximating contour,
   contours_polyFloodFill[i]

If the angular patterns resemble those of an arrow, we are likely looking at a connector.

Correlate the number of vertices and angular. patterns against in shapes in FIG. 4.

### Specifics of Method 2

Here we start from scratch again, accepting the original, cleaned-up image as input. Method 2 applies the findContours( ) function directly on this image (after mild dilation):
findContours(IMPORTED_IMAGE_ful1t, contoursMethod2, hierarchy, CV_RETR_TREE, CV_CHAIN_APPROX_SIMPLE, Point(0, 0));

Method 2 is tailored to images with a large number of loops, adjacent loops, etc. In this case, we do not afford to apply aggressive erosion during the preprocessing stage, given the risk of erasing parts of the lines comprising the graphical objects of interest (in which case accurate recognition becomes just about impossible). Method 2 frequently results in a fairly large number of contours, consisting of the primary objects of interest as well as adjacent objects and/or adjacent connectors, in various permutations. Although the contour validation (filtering) algorithms for Method 2 need to be more nuanced than for Method 1 (there usually are quite a bit larger number of contours to be thrown out for Method 2), the primary steps are the same.

Combining the Objects from Methods 1 and 2

The candidate objects from Method 2 are matched against the verified objects from Method 1, based on similarity of selected vector descriptors from each camp. If no match is found, the list of verified objects is appended to include the new candidate. Taking the ellipsoid as an example, the candidate object is declared as a match with a previously identified ellipsoid, and thus not included in the vector storing the confirmed ellipsoids, if
1. The absolute difference in the position of the y-component of the center of the candidate and any of the previously verified ellipsoids is less than 5% of the image height, AND
2. The absolute difference in the position of the x-component of the center of the candidate and the same previously verified ellipsoid is less than 5% of the image width, AND
3. The absolute difference in the major axis of the candidate and this same previously verified ellipsoid is less than 20% of the major axis of the verified ellipsoid, AND
4. The absolute difference in the minor axis of the candidate and this same previously verified ellipsoid is less than 20% of the minor axis of the verified ellipsoid, AND
5. The absolute difference in the degree of ellipsoidness (fDegreeOfEllipsoidness) is less than 5% between the candidate and the verified ellipsoid.

### Automatic Identification and Flagging of the Ambiguity Detections

The medium-dark gray color of

{r,g,b}={100,100,100} (10)

is reserved for highlighting the ambiguity detection. A verified object is flagged as an ambiguity detection if
1. The object is empty (i.e., it does not contain another object, text or an equation), AND
2. No verified connector links to the object, AND
3. The object size falls below the adaptive threshold (refer to Eq. (13)).

A verified connector is defined as a connector with a starting point or an ending point associated with a given graphical objects in the image.

### More on the Color Segmentation (Method 3)

The algorithm for the color segmentation consists of the following, primary steps:
1. Compute the histograms for the red, green and blue intensity pixels:

calcHist( &IMAGE_src_blue, 1, 0, Mat( ), b_hist, 1, &histSize,

&histRange, uniform, accumulate );

calcHist( &IMAGE_src_green, 1, 0, Mat( ), g_hist, 1, &histSize,

&histRange, uniform, accumulate );

calcHist( &IMAGE_src_red, 1, 0, Mat( ), r_hist, 1, &histSize,

&histRange, uniform, accumulate );

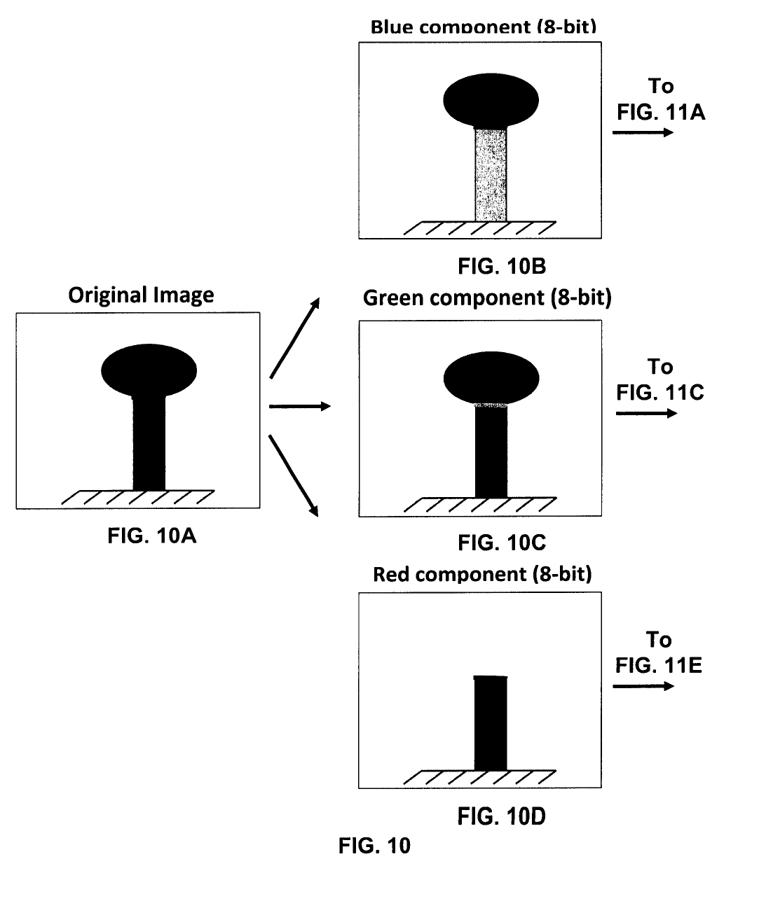

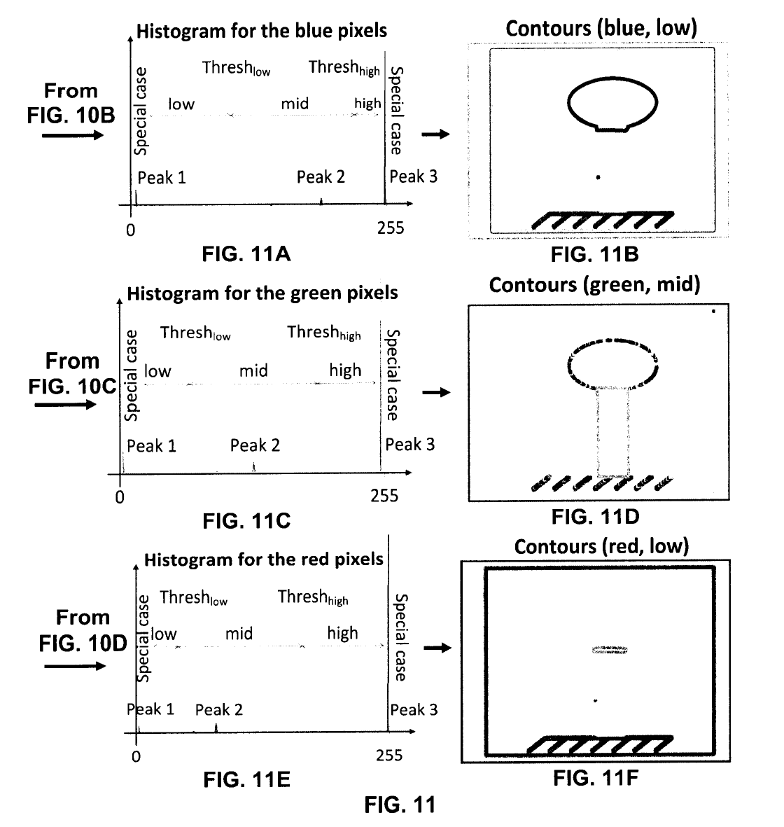

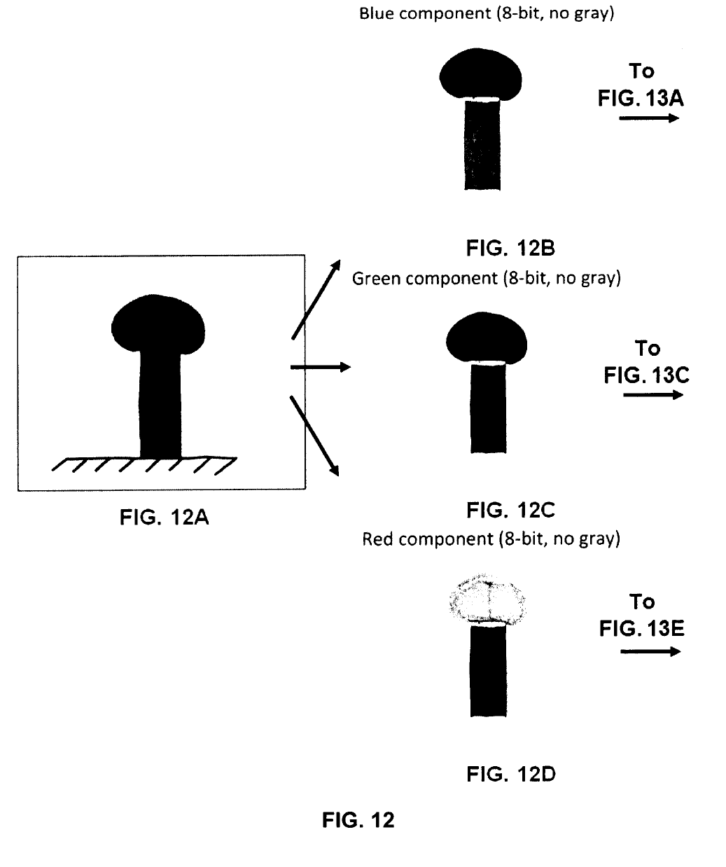

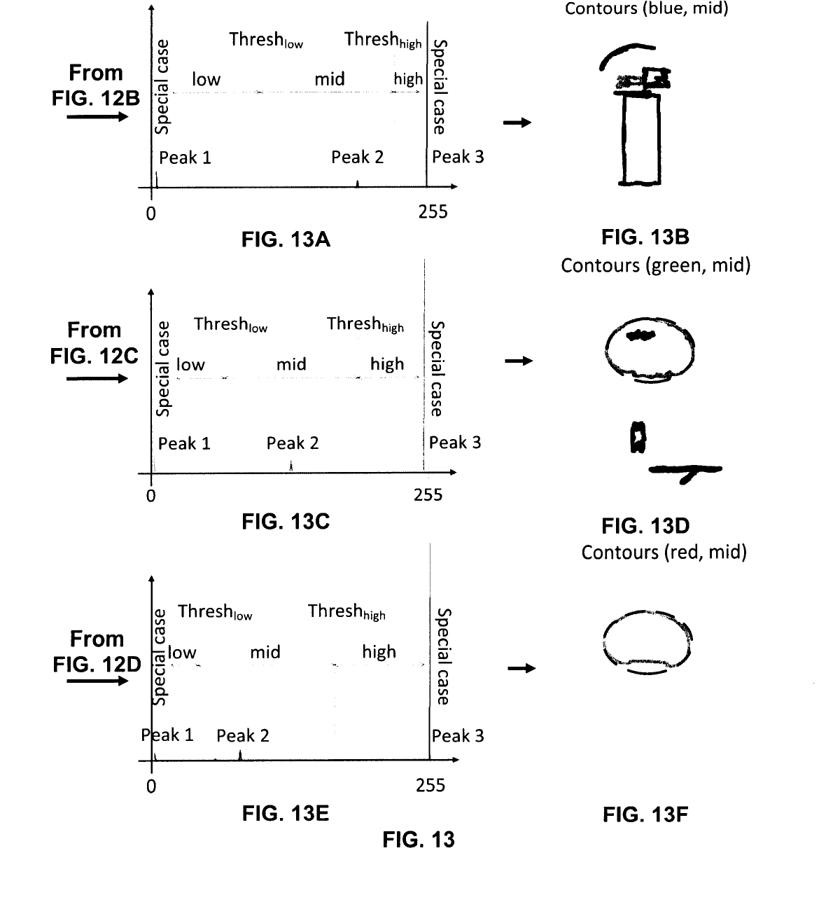

Sample histograms are presented in FIG. 11 and FIG. 13.
2. Determine the maximum peak, the 2^{nd} maximum and the 3^{rd} maximum for the blue, green and red channels, respectively.
   In FIG. 11 and FIG. 13, these are labeled as ‘Peak 1’, ‘Peak 2’ and ‘Peak 3’.
   Special conditions apply when the histograms contain less than 3 peaks.
3. Compute the upper and the lower threshold as the average of the peak positions:

Thres_{high}=(Peak_{—}2+Peak_{—}3)/2 (11)

Thresh_{low}=(Peak_{—}1+Peak_{—}2)/2 (12)
4. Threshold the blue, green and red intensity channels, depending on whether the pixels
   (a) fall below Thresh_{low} (→low range),
   (b) in between Thresh_{low} and Thresh_{high} (→mid range) or
   (c) exceed Thresh_{high} (→high range)
5. Separately search for contours within the now binarized blue_low, blue_mid, blue_high, green_low, green_mid, green_high, red_low, red_mid and red_high buffers. For the blue_low buffer, the function call takes the form

```
findContours( blue_low.clone( ), contours, hierarchy,
              CV_RETR_TREE, CV_CHAIN_APPROX_SIMPLE,
              Point(0, 0) );
```

6. Validate and combine the contours from the nine buffers listed in Step 5 using validation process analogous to that of Method 2 (see [0084]-[0086] and [0087]-[0088]).
7. Repeat Steps 1-6 using image buffers with the gray values excluded. Here IMAGE_src_blue_no_gray, IMAGE_src_green_no_gray and IMAGE_src_red_{—} no_gray replace IMAGE_src_blue, IMAGE_src_green and IMAGE_src_red.
   The names selected for the image buffers are intended to be representative. The same processing steps can be achieved with different naming conventions and without deviating from the scope of the invention.
   Refer to [0079]-[0080] for information on the procedure for removing the gray values.
   The removal tends to introduce spatial separation between the primary graphical objects, as shown in FIG. 12 (FIGS. 12B, 12C and 12D), erode the connectors as well as some of the text.
   Once the primary graphical objects have been separated, the contours can be assessed and the best fit for the candidate objects determined (see FIGS. 13B, 13D and 13F). The spatial separation allows one to arrive at contours confined to the objects of interest.
8. Validate and combine the object candidates, determined from the image buffers with the gray values removed, and correlate against the candidates, determined from the image buffers with the gray values included, using methods analogous to the ones described in [0089].
   Specifics of the Method for Separating the Unidentified Objects from the Connectors

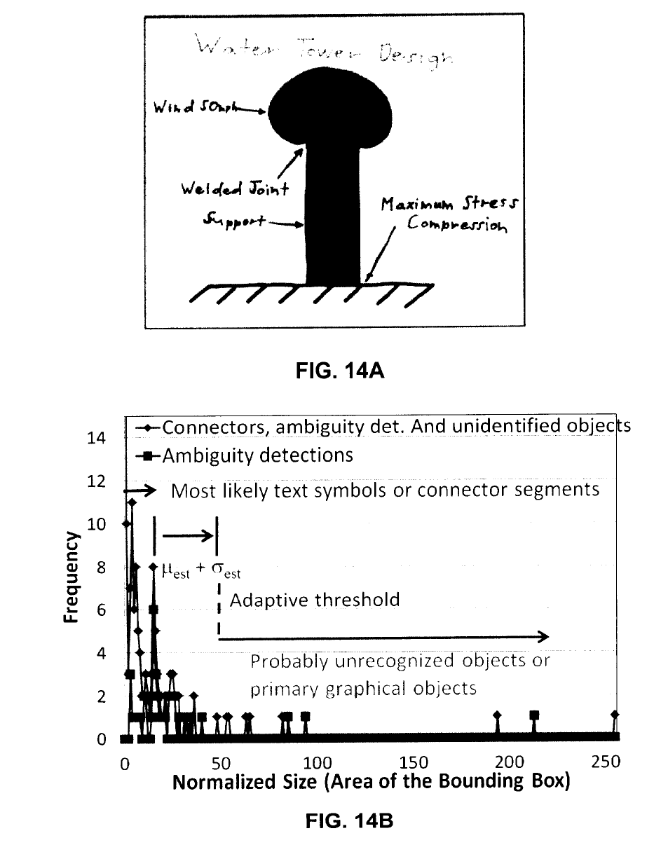

The apparatus for the automatic recognition and representation of the image sketches employs a normalized histogram approach, presented in FIG. 14B, for separating the unidentified objects from the connectors. This histogram approach consists of the following steps:
1. Determine the ambiguity detection, connector or unidentified object candidate whose bounding box has the largest area. Let's refer to this size as
   a_iMax_Size_BoundingBox
2. Determine the normalized size of each ambiguity detection, connector and unidentified object candidate by applying the normalization factor
   (256/a_iMax_Size_BoundingBox)
to the original areas of the bounding boxes.
3. Populate a histogram containing the normalized area occupied by the graphical objects flagged as ambiguity candidates. Let's call this histogram
   pi_AreaHistNorm_AmbiguityDetOnly[ ].
4. Populate a second histogram with the normalized areas of the graphical objects flagged as ambiguity detections, the size of the objects extracted from the pixel mask after eliminating the primary graphical objects. The latter objects correspond to the connectors and unidentified objects. Let's refer to this histogram as
   pi_AreaHistNorm_ConnectorsUnidentifiedObj[ ].

The maximum normalized area for both histograms is 256.
5. Determine the peak (mode) of the normalized histogram with the ambiguity detections, along with the estimated mean, μₑₛₜ, and standard deviation, σₑₛₜ.
   The mode defines a natural size metric in the image, corresponding to the most common size of the text symbols.
6. Compute a conservative estimate for the adaptive threshold as

Adaptive_threshold=μₑₛₜ+σₑₛₜ (13)
Any object whose normalized area exceeds the adaptive threshold in size should be considered ‘large’ relative to the text symbols.
These are our primary candidates for the unrecognized objects.
7. For the objects exceeding the adaptive threshold in size, apply additional checks pertaining to adjacency, presence of an arrow head, aspect ratio of the bounding box, adherence to a line structure and association with the graphical objects, to separate the unrecognized objects from the connectors.
   The connectors tend to be long and thin (with large aspect ratio), have an arrow head on one end as well as close proximity with at least one of the primary graphical objects.
   The unidentified objects, on the other hand, are not necessarily associated with the graphical objects, do not necessarily have large aspect ratio, no arrow head and are not necessarily follow a line structure, unlike the ambiguity detections.
   The key is to realize that the mode is determined from the histogram in Step 1, but the result is applied to the histogram from Step 2.

### Specifics of the Method for Counting the Number of Graphical Objects Recognized

The histogram approach, presented in FIG. 14B, also provides a procedure for counting the number of graphical objects recognized:
1. Determine the peak (mode) of the histogram with the ambiguity detections, using the procedure from [0093].
2. Present separate counts for the numbers of triangles, rectangles, polygons, ellipsoids, circles and unidentified objects
   Exceeding the adaptive threshold.
   Exceeding mode in the histogram for the ambiguity candidates.
   Collectively (comprehensive counts).

### Association of the Recognized Graphical Objects and the Handwritten Text

The association of the graphical objects and the handwritten text recognized is captured in the polymorphism implemented in the class structure behind the API, shown in FIG. 5. This class structure contains the generic class object cShape which allows us to define, in Hungarian notation, and through inheritance relationships, many of the class variables common to each of the graphical objects (cRectangle, cCircle, cEllipsoid, cPolygon, cTriangle and cUnidentifiedObject). The class cShape contains the object ID, iObjectID, data structures defining the nature of adjacency relationship with the neighboring objects, if any, as well as constructs specifying the color properties of the graphical object itself or of its line contour.

Another benefit of the master object structure, cShape, pertains to the efficiency in the implementation of the adjacency relationships (provisions for efficient identification of the neighboring objects). In Table 4, the connected objects, the adjacent objects, and the objects positioned inside a given graphical object, are defined as

vector <cShape *> ptrConnectedObjects;
vector <cShape *> ptrAdjacentObjects;
vector <cShape *> ptrInsideObjects;

By defining the vector of the pointers as being of the type cShape, it is possible to specify a single data structure for these objects inside cShape. There is no need to specify separate data structures for connected rectangles, circles, ellipsoids, polygons, triangles or unidentified objects. These are inherited from the generic, master structure.

Furthermore, the pointer specification enables direct access to the pertinent data structures. If the cShape structure contained, say, a vector of the object IDs for the connected objects, one would presumably have to search all the graphical objects verified for the one with the ID of interest. Direct access through pointers renders such searches unnecessary.

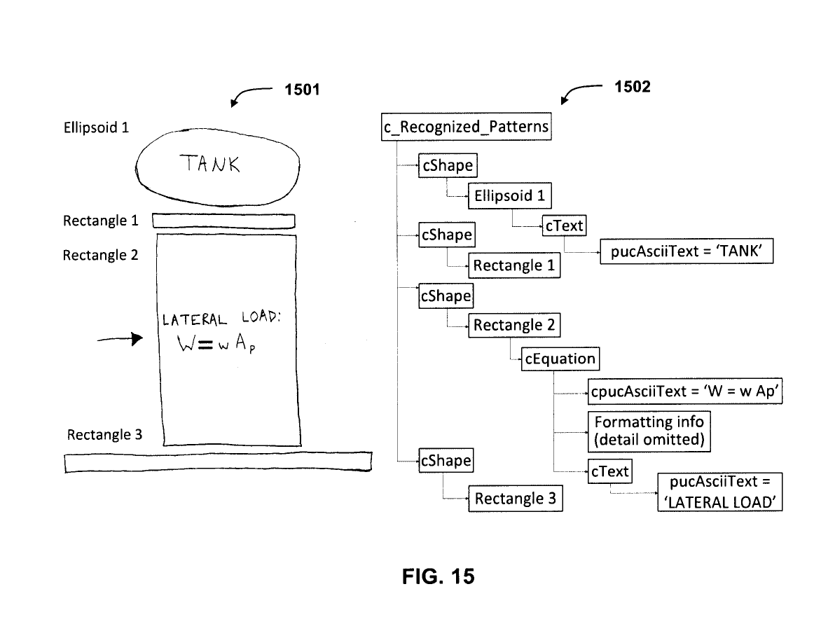

With the text included, the association is specified by the link between the graphical object and the inherited text object, cText. FIG. 15 provides a simple, practical example of such inheritance relationship. Here, the text ‘TANK’ is stored in the character vector pucAsciiText which belongs to the text object, cText, whose parent is Ellipsoid 1. In this way, the software is capable not only of recognizing the handwritten information, and representing in vector format, but also of understanding that the ellipsoid is associated with the ‘TANK’.

FIG. 14B provides another example of intelligence for taking advantage of the association of the graphical objects and the text, for the purpose of separating the two. The peak in the histogram for the ambiguity detections at the normalized size of 16 corresponds to the most common size of the text symbols. Looking at the other histogram, for the connectors, ambiguity detections and unidentified objects, one can conclude the objects yielding normalized size less than 16 correspond most likely to text symbols or connector segments. The objects exceeding (μₑₛₜ+σₑₛₜ) most likely correspond to the primary graphical objects or the unrecognized objects. For FIG. 14B, the normalized step size is 36 pixels.

### Association of the Recognized Objects and the Equations

The API in FIG. 5-FIG. 7 similarly captures the inheritance relationship between the recognized objects and the equations. It is, in particular, the link between the graphical objects (the classes cRectangle, cCircle, cEllipsoid, cPolygon, cTriangle and cUnidentifiedObject) and the cEquation class that defines this relationship. Applying this relationship to the illustrative example in FIG. 15, one can tell the equation

W=wAₚ (14)

is associated with Rectangle 2. The API captures this association by assigning

cpucAsciiText=‘W=wAp’ (15)

for the cEquation object inherited from Rectangle 2.

### Association of the Handwritten Text and the Equations

The API in FIG. 5-FIG. 7 also specifies how a text object can be associated with a stand-alone equation (refer to the link between items 530 and 531) as well as how a text object can inherit from an equation associated with a graphical object of a given type. For the latter, refer to the links between the equation and text classes in FIG. 6A, FIG. 6B, FIG. 6C, FIG. 6D, FIG. 7A and FIG. 7B. In terms of the practical illustration in FIG. 15, it is clear the text ‘LATERAL LOAD’ is associated with Equation (14), which again is the child of Rectangle 2. The API captures this relation in

cpucAsciiText[ ]=‘LATERAL LOAD’ (16)

of the cText class inherited from the cEquation object of Rectangle 2.

Once the association of the recognized text with the graphical objects, the relation of the equations with the recognized objects and the inter-relations between the text and the equations has all been specified, through the class hierarchy of the API, it is easy to issue the appropriate queries and immediately make use of the relationships. Alternative variations of the class hierarchy and the associations can be devised without deviating from the scope of this invention.

### 4. HOW TO USE THE INVENTION

Whether combined with a mining, analysis or assessment module, or used stand-alone, there exist many venues and opportunities, for making use of the recognized image sketch, presented in vector format:

1. Automatic Assessment of Student Compliance with Engineering Design Processes (Pedagogy)

The apparatus for the automatic image recognition and representation can be applied to the recognition of handwritten information from engineering design notebooks, for the purpose of extracting material pertaining to students' information gathering activities, or extracting information on design process activities. The ability to extract such information from the design notebooks, through mining and assessment, as a project develops over the course of a design class, will provide instructors with the opportunity to pedagogically intervene as the student teams develop the project. Specifically, such a tool can alert the instructor when the students are not able to apply the design process correctly in the development of concepts for a target artifact. FIG. 16 captures the flow diagram of the pattern recognition engine, used in conjunction with a mining and assessment engine, for the automatically assessing compliance with a given design process, for extracting information gathering activities or cognitive patterns or for objectively assessing a student's contributions to a group project.

2. Other Design or Lab Classes within Engineering, the Physical or the Natural Sciences (Academia)

The apparatus for the automatic image recognition and representation can be naturally extended to engineering and lab classes within the physical or natural sciences. From the perspective of the instructors, the apparatus will, when combined with a mining and assessment engine (see FIG. 16),
Allow the instructors to assess students' performance more quickly.
Allow instructors to assess students' performance with higher quality and less subjectivity.
Provide increased efficiency (due to fewer interruptions).
Provide easy means for preparing effective training material (presentations with side-by-side comparison of ‘expected’ vs. ‘observed’), resulting in enhanced teaching.

From the perspective of the students, the system in FIG. 16 will
Allow the students to prepare their lab or project reports faster, but without loss of quality by using the idealized vector representation of the sketches in formal reports.
Increase the chance of the students staying on track throughout the course, reducing the chance of unproductive activities.
Increase the students' efficiency, by virtue of the prompt notifications.
Enhance the students' creativity, by allowing them to quickly explore variations of a key design idea.

### 3. Bringing Amateur Designers Up to Speed on Internal Design Processes of Given Corporate Organizations

Engineering design companies, that wish to convert design notebooks into electronic format and interpret the content, provide training to amateur designers on the companies' internal design processes, or bring amateur designers up to speed by teaming them up with experienced designers (mentors), can also make effective use of the apparatus. Upon completion of a capstone design class, a large portion of engineering seniors will likely join industry. Given their desire to expedite the completion of the final project reports, stay on track throughout the design process and enhance creativity, by quickly sketching out variations of a key idea.

### 4. Other Technical and Scientific Professions, Such as at Companies Involved in Pharmacology or Biometrics

Apparatus providing automatic extraction of symbols from mathematical equations, chemical formulas or biometric sequences may benefit professionals at pharmaceutical or biometric companies, esp. if the extracted information is mined appropriately and presented through a convenient and appealing user interface.

### 5. Teaching Mathematics (all Age Groups)

The math program would consist of a user and instructor modes. The user client would be an application running on a tablet PC. The student would sketch down a solution to a problem using a stylus or even the finger. The hand sketched solution would be converted into vector graphics in real time and appear towards the bottom of the monitor display. The student would immediately see if the recognition was correct or if something needed to be fixed up. The application might provide separate modes (user interfaces) for inputting text, graphics and equations. Once the solution was complete, the application would allow the students to put the text, graphics and equations into a complete solution and e-mail to the instructor (as well as himself/herself), through a click or two. The instructor would receive solutions from 30 or more students. In the instructor mode, the software would automatically grade each student's solution against a template with the correct solution. Hence, the instructor would only need to look at the incorrect problems, say, for the purpose of awarding partial points. For large class sizes, the time savings might be considerable.

### 6. Collaboration: Follow-Up to Brainstorming Meetings

The apparatus for the automatic image recognition and representation can be used to expedite follow-up activities after brainstorming meetings at various organizations. During the meeting an attendee would draw up a sketch of a particular, predefined type, say, an organizational chart, a process flow diagram, an algorithm flow chart, a UML class diagram, a circuit diagram, math formulas, etc. The sketch could be provided using a stylus-like device on a tablet-like platform, by taking a photographic still image of a white board onto which a sketch had been drawn using a pen or by providing a link to a scanned in version of the sketch. The tool would recognize the interconnects (lines), as well as the objects which each interconnect is intended to connect, fully connect, and export the resulting drawing. This would eliminate the need of an employee spending time on creating an accurate sketch, with fully connected objects, in MS Visio or similar application. The exported .SVG file (cleaned-up sketch) could be e-mailed around, for further idea generation. New variations can be quickly generated by moving the vector objects around, deleting certain connectors, inserting new connectors, etc. The tool could shorten the follow-up activities from a typical project meeting by at least 10-15 minutes, if not more. One even could envision incorporating the apparatus in video whiteboard. Here, the attendees would simply need to push a single button, to receive a vectorized rendering of the sketch on the board, at the end of the brainstorming meeting.

### 7. Formal Documentation: Follow-Up to Brainstorming Meetings

Similarly, cleaned-up, vectorized representations of the image sketches, generated by the apparatus for automatic image recognition and representation, can be imported into MS Word for MS Powerpoint, for inclusion in formal project documents or presentations. Again, this would eliminate the need for an employee spending significant time redrawing the sketch in MS Visio, search for the components, drag, drop, look for the connector symbols, fully connect, etc. For companies in heavily regulated industries, these time savings could sum up quickly.

### 8. Collaboration: Tool Between Entrepreneurs, Inventors and CAD Engineers or Between R&D Product Design Teams and CAD Specialists

The apparatus for the automatic image recognition and representation can be used by R&D design teams that quickly want to sketch up ideas for new products and pass along to CAD specialists at given design companies for review and editing (1). The apparatus could also be used by entrepreneurs, inventors or even inventors that intend to quickly sketch up their ideas and pass along to CAD engineers. The apparatus could even be used to quickly generate an approximate CAD model from stylists' depiction (sketches) of next-generation vehicle models. The refined, vectorized representation of the sketch could be imported into MS Word, MS Powerpoint, MS Visio, LibreOffice Draw, or one of the CAD design tools for further modifications. This quick prototyping could facilitate exploration of many different design options (approx. CAD models) and provide means for rapid feedback.

9. CAD: Quickly Creating Reasonably Accurate and Modifiable CAD Models from 2D Images

Representatives from a given “company” (or “agency”) might visit a given site. The group might include some architects. They might quickly take a few pictures of a given “object”. This “object” might consist of a building, vehicle or even a weapon. The apparatus for the automatic image recognition and representation might quickly come up with a reasonably accurate and modifiable model of the “object”. This model could be imported into a CAD tool, paving the way for further analysis, modifications and even production.

### 10. Industrial Design, Architecting and the Graphical Arts

Some mechanical assembly diagrams are created by design artists, rather than engineers, at the beginning of a design project to get the “big picture”. The artists would place the parts in a logical, perspective layout and present the complete structure in a way that beautifully shows each and every sub-assembly. The apparatus for the image recognition and representation can be used to quickly map sketches of the assembly diagrams into CAD models.

### 11. Electrical CAD for Printed Circuit Boards: Schematic Symbol Creation

The apparatus for automatic image recognition and representation can be used to extract the schematic symbols straight from the data sheet. For every new device, many times the layout is in the data sheet. Those are time consuming to build and it is easy to make a mistake. With the apparatus of this invention, engineers can build libraries of new parts, for use in their designs, by automatically extracting schematics and layout information from the data sheet. For companies doing a lot of contract board design, the time savings resulting from the automatic extraction can be significant.

12. Medicine, Esp. Medical Imaging (Opthalmology)

When an optometrist or ophthalmologist analyzes patient's eyes, they currently look into the patient eyes and verbally provide information to their assistants regarding the profile of the eyes and location of defects. Based on this information, the assistants hand drawn the profiles and locate the eye defects. The hand drawn images are redrawn in specialized software and lenses generated from the electronic versions. The apparatus for image recognition and representation can be used to automatically recognize the hand drawn sketches of the eye profiles, and generate the electronic files, eliminating the need for the redrawing. Similar opportunities may exist within medical disciplines.

### 13. Patents: Creating a Repository of Information (Text and Graphics) for Monitoring Patent Infringements

The repository would not only store the textual content, but also graphical models and equations, from patents. Individuals or entities looking for infringements (patent lawyers, registered patent agents or paralegal assistants) could search the database looking for infringement. Here the set of patents belonging to a given university or industrial organization would be cross-referenced against cross-referenced against patents issued more recently. Conversely, one could cross-reference the specifications for a candidate patent against the existing patents in the database to find out if the candidate indeed contains novel and patentable material. In this way, patentable material can be recognized at an early stage and more completely that with a text-only search currently in use today.

14. Automatic Generation of C# Projects (Code) from UML Class Diagrams

Here, a software developer would draw a UML class diagram of a candidate design onto a white board, for example during a brainstorming session. The developer would take a picture of the white board and import into the apparatus for image recognition and representation. The .SVG files produced could be imported into MS Visio, exported again and then imported into MS Visual Studio (ver. 2012 or later) as a C# application. Here one would not need to type in the code, so a lot of time might be saved.

15. Automatic Generation of Database Systems from UML Diagrams

Resembling the previous use case, the developer would now draw UML diagrams showing tables in a database along with their internal relationships on the white board. But opposed to exporting the Visio diagram into MS Visual Studio, the developer would here export the Visio diagram into MS SQL or an Oracle database system.

### 16. Network Design

Network design engineers may create sketches of envisioned topologies. Similarly, network administrators may sketch up the topologies of the LAN or WAN configurations they are deploying. The apparatus for image recognition and representation can be used to convert sketches of network topologies into cleaned up diagrams for importing into MS Word, MS Powerpoint or MS Visio for archiving.

### 17. Web Authentication

One can use the apparatus for automatic image recognition and representation to recognize image sketches for “Captcha”-like applications, validating that the user is actually a real person, not a web bot (program). The image would consist of a series of geometrical structures. Using a stylus or a mouse, the user would sketch out individual objects which the software would validate. Or the user might be asked to fully outline particular sections of an image presented, for validation, e.g., a person's head or body.

### 18. Authentication for Smart Phones

Similar to use case 15, users might want to install a pre-defined image of choice for authentication of their smart phones. This might be a customized version of a smiley face, which the user would quickly draw on the smart phone, using a stylus or the finger tip, to gain access. The apparatus for automatic image recognition and representation would compare the sketch drawn against the pre-defined template to determine if the match is sufficient to allow access.

### 19. Automatic Generation of Schedules for MS Project

Here the user would sketch up a Gantt chart, typically on a white board, generate a picture (raster scan) and import into the apparatus for automatic image recognition and representation. The apparatus would interpret the sketch and generate a file (task list) that can be automatically imported into MS Project. The user would not need to retype the task list in MS Project.

### 20. Defect Identification (Metrology)

The graphics recognition section of the pattern recognition engine can be applied to the identification of defects introduced during fabrication of integrated circuits. Image processing solutions proposed in the past are considered inadequate. Large semiconductor manufacturers are still relying on humans, for most part, for identifying the defects.

### 5. FURTHER EXAMPLES OF THE INVENTION

It will be appreciated by those skilled in the art that the present invention is not restricted to the particular preferred embodiments described with reference to the drawings, and that variations may be made therein without departing from the scope of the invention.

What is claimed is:

1. An apparatus for recognizing and interpreting content in a human-drawn sketch, and for offering a vector representation of the sketch, the apparatus comprising:
a graphical user interface, configured to accept the user input (both the sketch and the configuration settings);
a recognition engine, configured to extract the patterns of choice from the sketch and return to the image logic through a standardized API in the form of a master entity with a hierarchical structure;
an image logic (database abstraction) module, configured to return the recognized vector objects to the GUI for display, store the recognized vector entities in a database, support querying of the state of each vector entity and pass all such entities to the vector graphics generator;
a vector graphics generator, configured to accept the vector entities from the image logic and generate a vector representation of the input sketch (an intermediate output);
a database system (or its proxy), configured to store the recognized vector entities along with dictionaries capturing the categories of valid graphical symbols and words (specific to the language selected);
error correction functionality, wherein the recognized objects are propagated from the recognition engine back to the GUI for visualization, user acceptance or modification; and
play-back mechanism, enabled by substituting the user input with a pre-recorded log file storing the user's past actions.

2. The apparatus according to claim 1, wherein the human-drawn sketch comprises a plurality of strokes, the apparatus further comprising a pattern recognition engine coupled to image logic and a vector graphics generator, configured to produce a vector graphics file (intermediate output) with vector representation of the human-drawn sketch, and if desired, a mining and assessment module.

3. The apparatus according to claim 1 wherein the user can specify the mode of operation, rendering configuration as well as categories of symbols to be searched for, the modes comprising ‘graphics recognition mode’, ‘text recognition mode’, ‘equation recognition mode’ or ‘error correction mode’, among others.

4. The apparatus according to claim 1, wherein the user can specify the rendering configuration as well as categories of symbols to be searched for, wherein the categories of valid symbols are stored in a dictionary (part of the database), wherein the recognized symbols are correlated against the valid symbols, and wherein the symbols are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.

5. The apparatus according to claim 1 wherein the human-drawn sketch is obtained from a platform consisting of: an engineering notebook, an image snapshot from a whiteboard, a raster image from an electronic whiteboard, a mobile computing device used in an engineering capstone design class, a mobile computing device used in a design or lab class within an engineering or scientific discipline, a mobile computing device used by corporate organizations for bringing amateur designers up to speed on their internal design processes, a mobile computing device used by technical or scientific professionals (such as personnel at companies involved in pharmacology or biometrics), a mobile computing device used by medical professionals (such as the primary practitioners of ophthalmology or their support staff), a mobile computing device used for teaching mathematics (all age groups), a mobile computing device used for brainstorming and collaboration in a corporate setting, mobile computing device used to exchange information (ideas) between entrepreneurs, inventors and CAD engineers or between R&D product design teams and CAD specialists, or by any computing platform providing capabilities for sketching patterns for which human-drawn symbols have well-known counterparts.

6. A method for recognizing and interpreting graphical content in a human-drawn sketch, comprising the steps of:
a method for automatic assessment of whether the input image is a true color or a grayscale image;
a procedure for edge detection, as a means for bringing out the contours of filled graphical objects (for ease of identification of the contours of such objects);
a method for automatic identification and elimination of ‘arrow-like’ or ‘T-like’ structures (accounting for rotation if necessary), for the purpose of separating the connectors from the graphical objects of interest;
a method for automatic identification of graphical objects in a grayscale image through a flood filling operation, combined with appropriate pre- and post-processing (erosion and dilation);
a method for automatic identification of graphical objects in a grayscale image through contour search;
a procedure for combining candidate objects extracted from flood filling with those obtained from direct contour identification; and
a procedure for automatically flagging ambiguity detections (small graphical objects that might correspond to text symbols).

7. The method according to claim 6 wherein the concept of ambiguity detection is defined through cross-association of graphical objects, text, equations and interconnects, such as a graphical object that is either empty (does not contain another object, text or an equation) or has no verified interconnect linking to it.

8. The method according to claim 6 wherein the human-drawn symbols are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.

9. A method for recognizing and interpreting graphical content in a human-drawn color sketch, comprising the steps of:
a method for splitting the color sketch into the red, green and blue components;
a method for applying a histogram approach separately to each color component (including the gray values), for the purpose of adaptively identifying the thresholds used for binarizing each color component and segmenting out the objects;
a procedure for combining the candidate objects, extracted from a given color component (gray values included), with the candidate objects, extracted from the other color components;
a procedure for eliminating gray values in a color image sketch and then splitting into red, green and blue components, for the purpose of introducing separation between the graphical objects;
a method for applying a histogram approach separately to each color component (gray values eliminated), for the purpose of adaptively identifying the thresholds used for binarizing each color component and segmenting out the objects; and
a procedure for combining the candidate objects, extracted from a given color component (gray values eliminated), with the candidate objects, extracted from the other color components.

10. The method according to claim 9 wherein the histogram approach consists of identifying the peaks in histogram of the intensity values for color components, determining the thresholds as the intensity values halfway between the peaks identified, and applying standard procedures (using established primitives) for identifying the contours in the binarized images that result from applying these threshold values.

11. The method according to claim 9 wherein the gray values are subtracted from an image buffer, derived from the original color image, when the pixel-wise difference between
the blue and green intensity buffer,
the green and red intensity buffer, and
the blue and red intensity buffer
each exceeds a pre-established threshold value.

12. The method according to claim 9 wherein the human-drawn symbols are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.

13. A method for extracting and interpreting the association between the graphical objects and the handwritten text, comprising the steps of:
an adaptive histogram approach for separating ambiguity detections, presumably corresponding to handwritten text symbols, from the primary graphical objects; and
a hierarchical dependence (inheritance relationship) between the class structures for the graphical objects and the handwritten text, an embodiment of which is captured in the API for the pattern recognition engine.

14. The method according to claim 13 wherein the hierarchy, defined by the API, specifies
association between adjacent objects in terms of a vector of pointers of same type as the generic, master class;
association between connected objects in terms of a vector of pointers of the same type as the generic, master class;
association between a given object and the smaller objects captured inside in terms of a pointers of the same type as the generic, master class;
association between a given text object (class) and the parent object through a parent object ID; and
representation of the recognized text in terms of vector descriptors.

15. An apparatus harnessing the method from claim 13 wherein the symbols used in the human-drawn graphical objects, and the text, are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.

16. A method for extracting and interpreting the association between the graphical objects and the equations, comprising the steps of: a method harnessing the hierarchical dependence (inheritance relationship) between the class structures for the graphical objects and the equations; and an embodiment of which is captured in the API for the pattern recognition engine.

17. The method according to claim 16 wherein the hierarchy, defined by the API, specifies
association between adjacent objects in terms of a vector of pointers of same type as the generic, master class;
association between connected objects in terms of a vector of pointers of the same type as the generic, master class;
association between a given object and the smaller objects captured inside in terms of a pointers of the same type as the generic, master class;
association between a given text object (class) and the parent object through a parent object ID; and
representation of the recognized equations in terms of vector descriptors.

18. An apparatus harnessing the method from claim 16 wherein the symbols used in the human-drawn graphical objects and equations are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.

19. A method for extracting and interpreting the association between the handwritten text and the equations, comprising the steps of: a method harnessing the hierarchical dependence (inheritance relationship) between the class structures for the handwritten text and the equations; and an embodiment of which is captured in the API for the pattern recognition engine.

20. An apparatus harnessing the method from claim 19 wherein the symbols used in the human-drawn text and equations are selected from a group comprising mechanical design, electrical circuit design, mathematics, biology, physics, chemistry, computer science, natural sciences, medicine, or any other science- or engineering-based discipline whose practitioners work with patterns for which the human-drawn symbols have well-known counterparts.
